(19) United States
(12) Patent Application Publication
(10) Pub. No.: US 2025/0342619 A1
(43) Pub. Date: Nov. 6, 2025

(54) PALMPRINT PICTURE GENERATION METHOD AND APPARATUS, STORAGE MEDIUM, PROGRAM PRODUCT, AND ELECTRONIC DEVICE

(71) Applicant: Tencent Technology (Shenzhen) Company Limited, Shenzhen (CN)

(72) Inventors: Lei SHEN, Shenzhen (CN); Ruixin ZHANG, Shenzhen (CN); Shouhong DING, Shenzhen (CN)

(73) Assignee: Tencent Technology (Shenzhen) Company Limited, Shenzhen (CN)

(21) Appl. No.: 19/269,150

(22) Filed: Jul. 15, 2025

Related U.S. Application Data
(63) Continuation of application No. PCT/CN2024/092752, filed on May 13, 2024.

(30) Foreign Application Priority Data
Jun. 20, 2023 (CN) 202310744612.0

(51) Int. Cl. G06T 11/00; G06V 10/774; G06V 40/12

(52) U.S. Cl. CPC G06T 11/00; G06V 10/774; G06V 40/12

(57) ABSTRACT

A palmprint picture generation method including obtaining a simulated palmprint picture including a simulated palmprint curve, inputting the simulated palmprint picture and a preset first noise vector into a target palmprint picture generator, and performing a plurality of downsampling operations and a plurality of upsampling operations on the simulated palmprint picture in sequence through the target palmprint picture generator to generate a target palmprint picture.

### CROSS-REFERENCE TO RELATED APPLICATIONS

This application is a continuation application of International Application No. PCT/CN2024/092752 filed on May 13, 2024, which claims priority to Chinese Patent Application No. 202310744612.0, filed with the China National Intellectual Property Administration on Jun. 20, 2023, the disclosures of each being incorporated by reference herein in their entireties.

### FIELD

The disclosure relates to the field of computers and communication technologies, and in particular, to a palmprint picture generation method and apparatus, a storage medium, a program product, and an electronic device.

### BACKGROUND

Palmprint recognition is a new generation of biometric recognition technology following fingerprint recognition and face recognition. Compared with the fingerprint recognition technology and the face recognition technology, palmprint is more conducive to protecting user privacy. Palmprint recognition involves fields including mobile payment, identity authentication, and the like, which are closely related to personal privacy and property security of users. Therefore, accuracy of recognition is extremely important.

At present, a to-be-trained palmprint picture matching model may be trained through a palmprint sample picture. However, during actual use, due to a difference in light of a picture collection device or a collection environment, collected palmprint pictures usually have different modalities, such as an infrared modality and a visible light modality. Therefore, the palmprint picture matching model may have errors in recognizing palmprint pictures of different modalities.

To minimize the recognition error, in a training stage, a large number of palmprint sample pictures of different modalities with the same palmprint line need to be used for training, so that the training process of the palmprint picture matching model is extremely dependent on the scale and diversity of the palmprint sample pictures. However, due to privacy of palmprint, palmprint pictures are difficult to obtain, and multi-modal palmprint pictures that satisfy the foregoing conditions are scarcer. Therefore, due to relatively low generation efficiency of a palmprint picture, the scale and diversity of the palmprint sample pictures in the training process of the palmprint picture matching model are insufficient, which causes a trained palmprint picture matching model to have poor recognition ability for the multi-modal palmprint pictures.

### SUMMARY

According to some embodiments, a palmprint picture generation method is provided, including: obtaining a simulated palmprint picture comprising a simulated palmprint curve obtained by combining curves of a target type; and inputting the simulated palmprint picture and a preset first noise vector into a target palmprint picture generator, and performing a plurality of downsampling operations and a plurality of upsampling operations on the simulated palmprint picture in sequence through the target palmprint picture generator to generate a target palmprint picture, wherein each of the downsampling operations comprises performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and wherein each of the upsampling operations comprises performing upsampling processing on the inputted picture representation vector to obtain an upsampled picture representation vector, and performing noise addition processing on the upsampled picture representation vector through the first noise vector, to obtain a noise-added picture representation vector.

According to some embodiments, a palmprint picture generation apparatus is further provided, including: at least one memory configured to store computer program code; and at least one processor configured to read the program code and operate as instructed by the program code, the program code comprising: obtaining code configured to cause at least one of the at least one processor to obtain a simulated palmprint picture, the simulated palmprint picture comprising a simulated palmprint curve obtained by combining curves of a target type; and input code configured to cause at least one of the at least one processor to input the simulated palmprint picture and a preset first noise vector into a target palmprint picture generator, and perform a plurality of downsampling operations and a plurality of upsampling operations on the simulated palmprint picture in sequence through the target palmprint picture generator, to generate a target palmprint picture, wherein each of the downsampling operations comprises performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and wherein each of the upsampling operations comprises performing upsampling processing on the inputted picture representation vector to obtain an upsampled picture representation vector, and performing noise addition processing on the upsampled picture representation vector through the first noise vector, to obtain a noise-added picture representation vector.

Some embodiments provide a non-transitory computer-readable storage medium storing computer code which, when executed by at least one processor, causes the at least one processor to at least: obtain a simulated palmprint picture comprising a simulated palmprint curve obtained by combining curves of a target type; and input the simulated palmprint picture and a preset first noise vector into a target palmprint picture generator, and perform a plurality of downsampling operations and a plurality of upsampling operations on the simulated palmprint picture in sequence through the target palmprint picture generator to generate a target palmprint picture, wherein each of the downsampling operations comprises performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and wherein each of the upsampling operations comprises performing upsampling processing on the inputted picture representation vector to obtain an upsampled picture representation vector, and performing noise addition processing on the upsampled picture representation vector through the first noise vector, to obtain a noise-added picture representation vector.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone:

FIG. 1 is a flowchart of palmprint recognition according to some embodiments.

FIG. 2 is a schematic diagram of an application environment of a palmprint picture generation method according to some embodiments.

FIG. 3 is a flowchart of a palmprint picture generation method according to some embodiments.

FIG. 4 is a schematic diagram of a picture representation vector according to some embodiments.

FIG. 5 is schematic diagram of generation of an i^{th} noise-added picture representation vector according to some embodiments.

FIG. 6 is a schematic diagram of performing noise addition processing on a picture representation vector by a conditional generation submodule in an i^{th} downsampling module according to some embodiments.

FIG. 7 is a schematic structural diagram of a conditional generation submodule according to some embodiments.

FIG. 8 is a schematic diagram of generation of a j^{th} noise-added picture representation vector according to some embodiments.

FIG. 9 is a schematic diagram of performing noise addition processing on a picture representation vector by a conditional generation submodule in a j^{th} downsampling module according to some embodiments.

FIG. 10 is a schematic diagram of a first convolution processing and second convolution processing according to some embodiments.

FIG. 11 is a schematic diagram of a training process of a to-be-trained palmprint picture generator according to some embodiments.

FIG. 12 is a schematic diagram of determining a target loss value through a first loss value according to some embodiments.

FIG. 13 is a schematic diagram of determining a target loss value through a first loss value and second loss value according to some embodiments.

FIG. 14 is a schematic diagram of determining a target loss value through a first loss value, second loss value, and third loss value according to some embodiments.

FIG. 15 is a schematic diagram of determining a target loss value through a first loss value, second loss value, third loss value, and fourth loss value according to some embodiments.

FIG. 16 is a schematic diagram of determining a target loss value through a first loss value, second loss value, third loss value, fourth loss value, and fifth loss value according to some embodiments.

FIG. 17 is a schematic diagram of an overall block diagram of a palmprint picture generation algorithm according to some embodiments.

FIG. 18 is a schematic structural diagram of a target palmprint picture generator according to some embodiments.

FIG. 19 is a schematic structural diagram of an encoder according to some embodiments.

FIG. 20 is a schematic diagram of a generated target palmprint picture according to some embodiments.

FIG. 21 is a structural block diagram of a palmprint picture generation apparatus according to some embodiments.

FIG. 22 is a schematic structural diagram of an electronic device according to some embodiments.

FIG. 23 is a structural block diagram of a computer system of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provide a palmprint picture generation method and apparatus, a storage medium, a program product, and an electronic device, to at least resolve a technical problem of relatively low generation efficiency of a palmprint picture.

First, some terms that appear in the descriptions of the embodiments of this application are explained as follows:

ROI is an abbreviation for region of interest.

LReLU: It is a type of activation function, and is an abbreviation for leaky rectified linear unit. It is similar to a conventional ReLU, but the difference is that when an input x is less than 0, LReLU will have a small slope instead of an output of 0, which may improve a model training effect in some cases.

Flatten: It is a function for flattening a multidimensional array into a one-dimensional array, and used in a neural network. In a deep learning model, a Flatten layer is usually configured for flattening input data into a single vector for further processing.

BN, an abbreviation for batch normalization, is a widely used neural network layer, and can accelerate a training process and improve model accuracy.

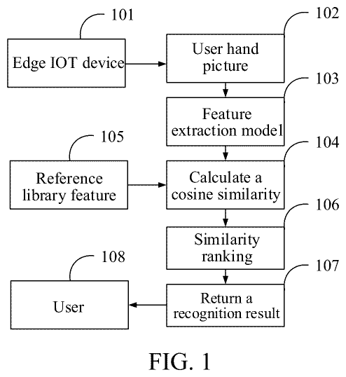

Generation of a palmprint picture may be applied to the palmprint recognition technology. Palmprint recognition scenes using the palmprint recognition technology are briefly described below. As shown in FIG. 1, a palmprint recognition scene may include the following operations:
1) collecting a user hand picture 102 through a terminal device (for example, an edge Internet of Things (IoT) device 101, including a terminal payment device and an identity (ID) collection device), which may specifically be a palm picture of a user, and extracting an ROI;
2) inputting the user hand picture 102 into a feature extraction model 103 (which may be understood as the foregoing palmprint picture matching model) to obtain a hand feature, for example, a feature vector of a palm; and
3) calculating a cosine similarity 104 between the user hand feature and a reference library feature 105, sorting similarities 106, and using ID information corresponding to the reference library feature (such as a reference library photo) with the highest similarity as a recognition result, and returning the recognition result 107 to the user 108, the foregoing reference library feature being a feature corresponding to a palm picture pre-stored by the user for representing user ID, which may mean that one user corresponds to a unique set of reference library features.

Based on the foregoing process, it may be seen that the ability of the feature extraction model to extract the user hand picture is to directly determine the accuracy of the recognition result. In an actual palmprint recognition scene, different types of terminal devices lead to a difference in modalities of collected user hand pictures, so that the feature extraction model may accurately extract user hand pictures of various modalities. Therefore, in the training stage of the feature extraction model, a large number of palmprint sample pictures of different modalities with the same palmprint line need to be used for training. However, the palmprint sample pictures with the foregoing conditions are difficult to obtain due to privacy of palmprint. In the related art, a sample volume obtained by artificially collecting palmprint of a real person is relatively small, and multi-modal palmprint pictures are scarcer, which causes the trained palmprint picture matching model to have poor recognition ability for the multi-modal palmprint pictures.

The related information (including but not limited to user device information, user personal information, and the like) and data (including but not limited to data for display and data for analysis) involved in this application are all authorized by the user or information and data fully authorized by all parties. For example, an interface is arranged between this system and a relevant user or institution. Before relevant information is obtained, an obtaining request needs to be transmitted to the foregoing user or institution through the interface, and the relevant information is obtained after consent information fed back by the foregoing users or institution is received.

According to some embodiments, a palmprint picture generation method is provided. In some embodiments, the foregoing palmprint picture generation method may be, but is not limited to, applied to a terminal device, a server, or the like, which may be, but is not limited to, an example in which the palmprint picture generation method is applied to a terminal device is used for explanation and description.

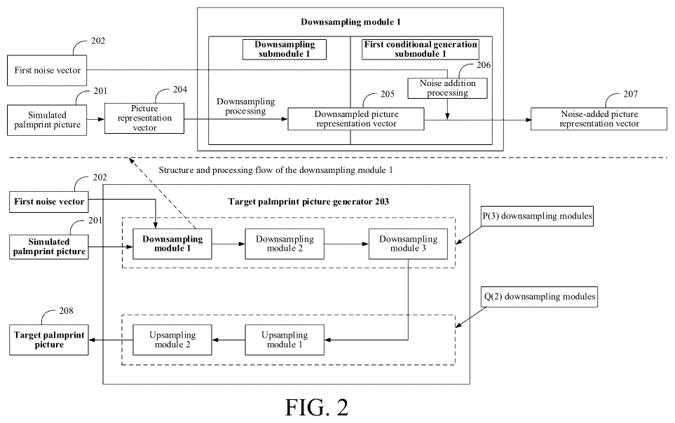

As shown in FIG. 2, the palmprint picture generation method is described by using a value of P being 3 and a value of Q being 2 as an example.

First, a simulated palmprint picture 201 is obtained, the simulated palmprint picture 201 including a simulated palmprint curve obtained by combining curves of a target type.

The simulated palmprint picture 201 and a first noise vector 202 are inputted into a trained target palmprint picture generator 203 (also referred to as a target palmprint picture generator 203), the target palmprint picture generator 203 being configured to pass the simulated palmprint picture through P(3) downsampling modules (a downsampling module 1, a downsampling module 2, and a downsampling module 3) in sequence and Q(2) upsampling modules (an upsampling module 1 and an upsampling module 2).

The downsampling operation in the target palmprint picture generator 203 may be performed through the downsampling module, and the upsampling operation in the target palmprint picture generator may be performed through the upsampling module. The downsampling processing may be performed through a downsampling submodule, and the upsampling processing may be performed through an upsampling submodule. The conditional generation submodule may perform noise addition processing on a sampled (downsampled or upsampled) picture representation vector through the first noise vector, to obtain a noise-added picture representation vector.

Each of the P(3) downsampling modules includes a downsampling submodule and a first conditional generation submodule. The downsampling module 1 is used as an example. The downsampling submodule 1 is configured to perform downsampling processing on an inputted picture representation vector 204 to obtain a downsampled picture representation vector 205. A first conditional generation submodule 1 is configured to perform noise addition processing 206 on the downsampled picture representation vector 205 through the first noise vector 202, to obtain a noise-added picture representation vector 207.

Each of the Q(2) upsampling modules (an upsampling module 1 and an upsampling module 2) includes an upsampling submodule and a second conditional generation submodule. The upsampling submodule is configured to perform upsampling processing on an inputted picture representation vector to obtain an upsampled picture representation vector. The second conditional generation submodule is configured to perform the noise addition processing on the upsampled picture representation vector through the first noise vector, to obtain a noise-added picture representation vector.

The flow order of data (picture representation vectors) in the target palmprint picture generator is successively the downsampling module 1, the downsampling module 2, the downsampling module 3, the upsampling module 1, and the upsampling module 2, and finally a target palmprint picture 208 is obtained. The noise-added picture representation vector outputted by the previous sampling module (a downsampling module or an upsampling module) is the picture representation vector inputted by the next sampling module, and an input of the downsampling module 1 is a denoised picture representation vector.

In some embodiments, the foregoing terminal device may be a terminal device configured with a target client, which may include but is not limited to at least one of the following: a mobile phone (such as an Android mobile phone and an iOS mobile phone), a notebook computer, a tablet computer, a palmtop, a mobile Internet device (MID), a PAD, a desktop computer, and a smart television. The target client may be a video client, an instant messaging client, a browser client, an education client, and the like. The foregoing network may include but is not limited to a wired network and a wireless network. The wired network includes a local area network, a metropolitan area network, and a wide area network. The wireless network includes Bluetooth, Wi-Fi, and another network that implements wireless communication. The foregoing server may be a single server, or may be a server cluster composed of a plurality of servers, or a cloud server. The foregoing is merely an example, which is not limited herein.

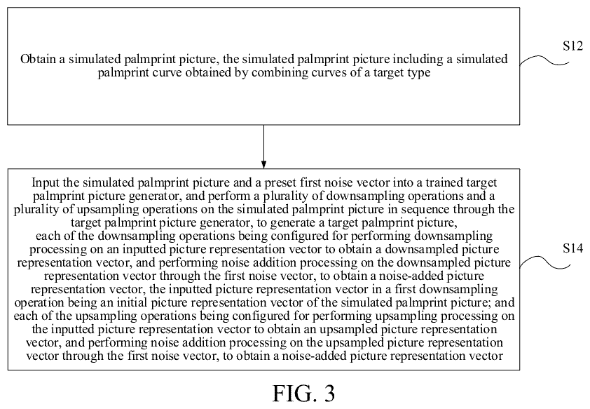

In some embodiments, as shown in FIG. 3, the foregoing palmprint picture generation method includes the following operations.

Operation S12: Obtain a simulated palmprint picture, the simulated palmprint picture including a simulated palmprint curve obtained by combining curves of a target type.

Operation S14: Input the simulated palmprint picture and a preset first noise vector into a trained target palmprint picture generator, and perform a plurality of downsampling operations and a plurality of upsampling operations on the simulated palmprint picture in sequence through the target palmprint picture generator, to generate a target palmprint picture,
each of the downsampling operations being configured for performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and
each of the upsampling operations being configured for performing upsampling processing on the inputted picture representation vector to obtain an upsampled picture representation vector, and performing noise addition processing on the upsampled picture representation vector through the first noise vector, to obtain a noise-added picture representation vector.

In some embodiments, in the generation process of the target palmprint picture, only the simulated palmprint picture and the first noise vector need to be inputted into the trained target palmprint picture generator.

Different from the related art that relies on artificial collection of palmprint of a real person, and for palmprint of the same real person, pictures (which may be understood as the foregoing target palmprint pictures) of different modalities further need to be collected a plurality of times as a set of palmprint pictures, to train a to-be-trained palmprint picture matching model, this application does not need artificial collection, and pictures (which may be understood as the foregoing target palmprint pictures) of different modalities and consistent palmprint line features may be generated as a set of palmprint pictures only through the simulated palmprint picture and the first noise vector, which greatly improves the generation efficiency of the target palmprint picture, and resolves the problem that in the related art, a relatively small sample volume is obtained through artificial collection of palmprint of a real person as a result of the privacy of palmprint being difficult to obtain, and multi-modal palmprint pictures are scarcer, causing the trained palmprint picture matching model to have poor recognition ability for the multi-modal palmprint pictures.

In some embodiments, the target palmprint pictures may be used as a set of palmprint pictures to train the to-be-trained palmprint picture matching model, to obtain a target palmprint picture matching model, so that the target palmprint picture matching model may accurately extract user hand pictures (palmprint pictures) of various modalities. Therefore, in the training stage of the feature extraction model, a large number of target palmprint pictures of different modalities with the same palmprint line need to be used as a set of palmprint pictures for training.

In some embodiments, the obtained simulated palmprint picture and the first noise vector are inputted into the trained target palmprint picture generator. The simulated palmprint picture includes a simulated palmprint curve obtained by combining curves of a target type, and the target palmprint picture generator successively performs a plurality of downsampling operations and a plurality of upsampling operations on the simulated palmprint picture to generate a target palmprint picture, each of the downsampling operations being configured for performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and each of the upsampling operations being configured for performing upsampling processing on an inputted picture representation vector to obtain an upsampled picture representation vector, and performing noise addition processing on the upsampled picture representation vector through the first noise vector to obtain a noise-added picture representation vector. Through the foregoing processing, the target palmprint picture obtained by processing the simulated palmprint picture by the target palmprint picture generator retains the feature of the simulated palmprint curve of the simulated palmprint picture. In addition, since the noise addition processing is performed on the sampled picture representation vector through the first noise vector in the foregoing downsampling operation and upsampling operation, the generated target palmprint pictures may have different modalities, so that a large number of target palmprint pictures of different modalities with the same palmprint line may be generated based on the simulated palmprint pictures, thereby achieving the technical effect of improving the generation efficiency of palmprint pictures, and further resolving the technical problem of low generation efficiency of palmprint pictures.

In some embodiments, the inputting the simulated palmprint picture and a first noise vector into a trained target palmprint picture generator, and performing a plurality of downsampling operations and a plurality of upsampling operations on the simulated palmprint picture in sequence through the target palmprint picture generator, to generate a target palmprint picture further includes the following operations.

S21: Determine the initial picture representation vector of the simulated palmprint picture based on the simulated palmprint picture.

S22: Perform the downsampling operation on the initial picture representation vector through the P downsampling modules in sequence, to obtain a P^{th} noise-added picture representation vector, each of the P downsampling modules including a downsampling submodule and a first conditional generation submodule,
the downsampling submodule being configured to perform the downsampling processing on the inputted picture representation vector, to obtain a downsampled picture representation vector, and
the first conditional generation submodule being configured to perform noise addition processing on the downsampled picture representation vector through the first noise vector, to obtain a noise-added picture representation vector.

S23: Perform the upsampling operation on the P^{th} noise-added picture representation vector through the Q upsampling modules in sequence, to obtain a Q^{th} noise-added picture representation vector, each of the Q upsampling modules including an upsampling submodule and a second conditional generation submodule,
the upsampling submodule being configured to perform the upsampling processing on the inputted picture representation vector to obtain an upsampled picture representation vector, and
the second conditional generation submodule being configured to perform the noise addition processing on the upsampled picture representation vector through the first noise vector, to obtain a noise-added picture representation vector.

S24: Generate the target palmprint picture based on the Q^{th} noise-added picture representation vector.

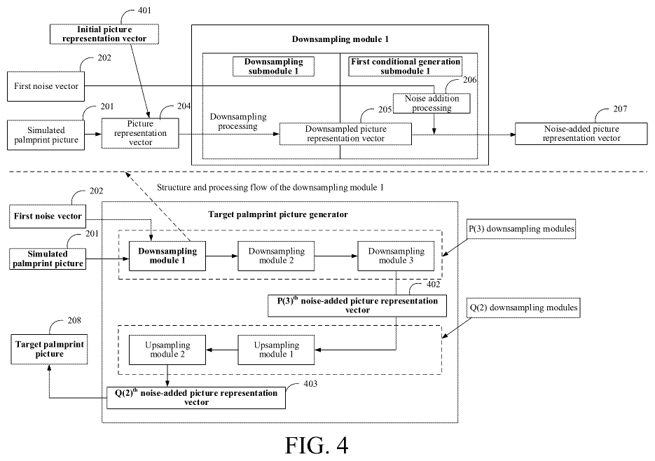

In some embodiments, as shown in FIG. 4, an initial picture representation vector 401, a P^{th} noise-added picture representation vector 402, and a Q^{th} noise-added picture representation vector 403 are shown by using a value of P being 3 and a value of Q being 2 as an example. The target palmprint picture generator is configured to pass the simulated palmprint picture through P(3) downsampling modules (a downsampling module 1, a downsampling module 2, and a downsampling module 3) and Q(2) upsampling modules (an upsampling module 1 and an upsampling module 2). The picture representation vector inputted by the downsampling module 1, as the first sampling module that receives the picture representation vector, is the initial picture representation vector 401 corresponding to the foregoing simulated palmprint picture. Subsequently, the picture representation vector inputted by each sampling module (an upsampling module or a downsampling module) is a noise-added picture representation vector outputted by the previous sampling module. For example, the downsampling module 3, as the last downsampling module, outputs a P(3)^{th} noise-added picture representation vector 402, and the P(3)^{th} noise-added picture representation vector 402 is the picture representation vector inputted by the upsampling module 1. The upsampling module 2, as the last upsampling module, outputs a Q(2)th noise-added picture representation vector 403. Thereafter, the target palmprint picture is generated based on the Q(2)^{th} noise-added picture representation vector 403.

In some embodiments, the performing the downsampling operation on the initial picture representation vector through the P downsampling modules in sequence, to obtain a P^{th} noise-added picture representation vector includes the following operation.

S31: Obtain an i^{th} noise-added picture representation vector through the following operations, i being a positive integer greater than or equal to 1 and less than or equal to P;
perform, through the downsampling submodule in an i^{th} downsampling module, the downsampling processing on the picture representation vector inputted into the i^{th} downsampling module, to obtain an i^{th} downsampled picture representation vector; and
perform, through the first conditional generation submodule in the i^{th} downsampling module, the noise addition processing on the i^{th} downsampled picture representation vector by using the first noise vector, to obtain an i^{th} noise-added picture representation vector.

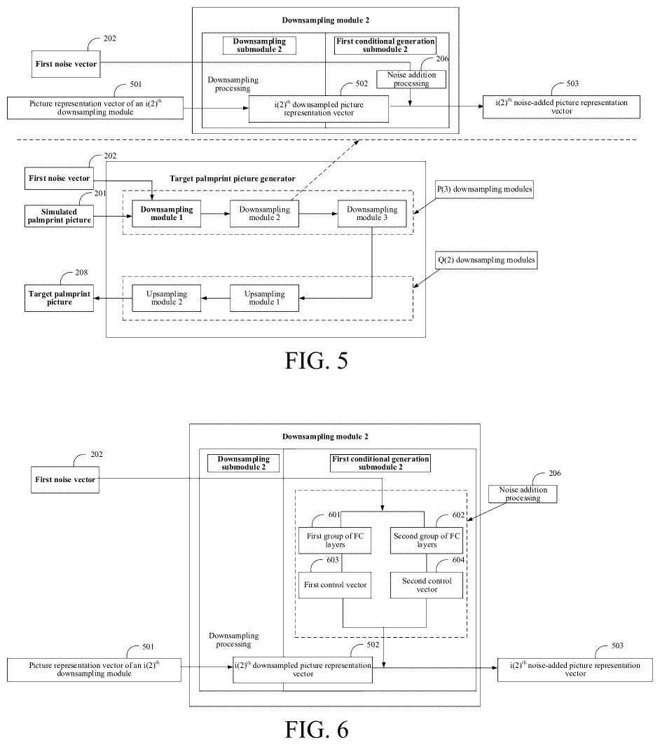

In some embodiments, as shown in FIG. 5, the operation of generating an i(2)^{th} noise-added picture representation vector 502 is described by using a value of i being 2 as an example. The value of i is 2. The downsampling processing is performed on the inputted picture representation vector 501 of the i(2)^{th} downsampling module through the downsampling submodule 2 in the i(2)^{th} downsampling module (the downsampling module 2), to obtain the i(2)^{th} downsampled picture representation vector 502. A first conditional generation submodule 2 performs the noise addition processing on the i(2)^{th} downsampled picture representation vector 502 through the first noise vector, to obtain an i(2)^{th} noise-added picture representation vector 503.

In some embodiments, the first conditional generation submodule includes a first group of fully connected (FC) layers and a second group of FC layers, and the performing, through the first conditional generation submodule in the i^{th} downsampling module, the noise addition processing on the i^{th} downsampled picture representation vector by using the first noise vector, to obtain an i^{th} noise-added picture representation vector includes the following operations.

S41: Pass the first noise vector through the first group of FC layers to output a first control vector, and
pass the first noise vector through the second group of FC layers to output a second control vector.

S42: Perform, based on the first control vector and the second control vector, the noise addition processing on the i^{th} downsampled picture representation vector, to obtain the i^{th} noise-added picture representation vector.

In some embodiments, as shown in FIG. 6, the process of performing, by a conditional generation submodule, noise addition processing on a picture representation vector is described by using a value of i being 2 as an example. The performing, through the first conditional generation submodule 2 in the i(2)^{th} downsampling module (the downsampling module 2), the noise addition processing on the i(2)^{th} downsampled picture representation vector 502 by using the first noise vector 202, to obtain an i(2)^{th} noise-added picture representation vector 503 includes: passing the first noise vector 202 through a first group of FC layers 601 in the first conditional generation submodule 2 to obtain a first control vector 603, and passing the first noise vector 202 through a second group of FC layers 602 in the first conditional generation submodule 2 to obtain a second control vector 604; and performing, based on the first control vector 603 and the second control vector 604, the noise addition processing on the i(2)^{th} downsampled picture representation vector 502, to obtain the i(2)^{th} noise-added picture representation vector 503.

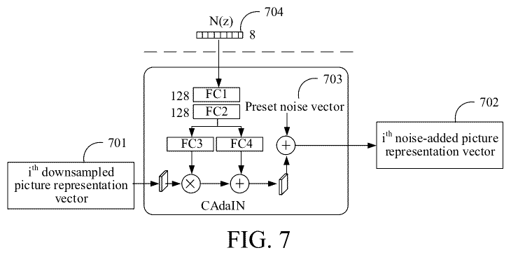

In some embodiments, as shown in FIG. 7, CAdaIN, namely a conditional generation submodule, includes 4 FC layers, which are respectively FC1, FC2, FC3, and FC4. N(z) is the foregoing first noise vector. N(z) is successively inputted into FC1 and FC2 and then two branches after being outputted from FC2, and enters FC3 and FC4 respectively. FC1, FC2, and FC3 included in one branch constitute the foregoing first group of FC layers, and FC1, FC2, and FC4 included in the other branch constitute the foregoing second group of FC layers. After an i^{th} downsampled picture representation vector 701 is inputted into the CAdaIN, noise addition processing is performed on the i^{th} downsampled picture representation vector through the first control vector outputted by the first group of FC layers (FC1, FC2, and FC3) and the second control vector outputted by the second group of FC layers (FC1, FC2, and FC4), i.e., a preset noise vector 703 is superimposed, to obtain an i^{th} noise-added picture representation vector 702.

In some embodiments, the foregoing N(z) is the foregoing first noise vector. After N(z) is inputted into the CAdaIN, the first noise vector N(z) may further be sampled to obtain an 8-dimensional Gaussian noise sampling signal 704, and then the 8-dimensional Gaussian noise sampling signal 704 is encoded into a 128-dimensional hidden control vector through 4 continuous FC layers (FC1, FC2, FC3, and FC4). A mean value and a variance of an input feature map are adjusted through the hidden control vector.

In some embodiments, the foregoing manner of sampling the first noise vector N(z) to obtain the 8-dimensional Gaussian noise sampling signal 704 is described herein. If a dimension of the first noise vector N(z) is greater than or equal to 8 dimensions, such as 10 dimensions, an order of values of all the original 10 dimensions may be retained, and values of 8 dimensions are arbitrarily extracted as the 8-dimensional Gaussian noise sampling signal.

In some embodiments, the performing, based on the first control vector and the second control vector, the noise addition processing on the i^{th} downsampled picture representation vector, to obtain the i^{th} noise-added picture representation vector includes the following operations.

S51: Multiply the first control vector by the i^{th} downsampled picture representation vector to obtain a first picture representation vector, and add the first picture representation vector and the second control vector together to obtain a second picture representation vector, the first control vector being a control vector determined based on a sampling vector, the second control vector being a control vector determined based on the sampling vector, and the sampling vector being a vector obtained by sampling the first noise vector.

S52: Determine the second picture representation vector as the i^{th} noise-added picture representation vector, or add the second picture representation vector and a preset noise vector together to obtain the i^{th} noise-added picture representation vector, the preset noise vector and the sampling vector, and the second picture representation vector having the same dimension.

In some embodiments, the foregoing process may be implemented by, but not limited to, the following calculation manner.

X₁ is obtained through the following equation:

$${X}_{1} = {fc}_{1} ( w ( z ) ) {X}_{i} + {fc}_{2} ( w ( z ) )$$

where w(z) is a sampling vector obtained by sampling the first noise vector, fc₁(w(z)) is the first control vector, fc₂(w(z)) is the second control vector, and Xᵢ is the i^{th} downsampled picture representation vector.

X₁ is determined as the i^{th} noise-added picture representation vector, or X₁ and the preset noise vector are superimposed to obtain the i^{th} noise-added picture representation vector, the preset noise vector, the sampling vector, and X₁ having the same dimension.

In some embodiments, w(z) is a sampling vector obtained by sampling the first noise vector, the sampling vector being the foregoing 8-dimensional Gaussian noise sampling signal 704.

In some embodiments, two manners of determining the i^{th} noise-added picture representation vector are as follows:

1) No noise addition is performed, and X₁ is directly determined as the i^{th} noise-added picture representation vector.

2) X₁ and the preset noise vector 703 in FIG. 7 are superimposed to obtain the i^{th} noise-added picture representation vector, which is different from the manner in 1), and a preset noise vector of the same scale is added at an output position, which may further increase diversity of generated samples (which may be understood as noise-added picture representation vectors).

In some embodiments, the performing the upsampling operation on the P^{th} noise-added picture representation vector through the Q upsampling modules in sequence, to obtain a Q^{th} noise-added picture representation vector includes the following operation.

S61: Obtain a j^{th} noise-added picture representation vector through the following operations, j being a positive integer greater than or equal to 1 and less than or equal to Q:
performing, through the upsampling submodule in a j^{th} upsampling module,
the upsampling processing on the picture representation vector inputted into the j^{th} upsampling module, to obtain a j^{th} upsampled picture representation vector; and performing, through the second conditional generation submodule in the j^{th} upsampling module, the noise addition processing on the j^{th} upsampled picture representation vector by using the first noise vector, to obtain a j^{th} noise-added picture representation vector.

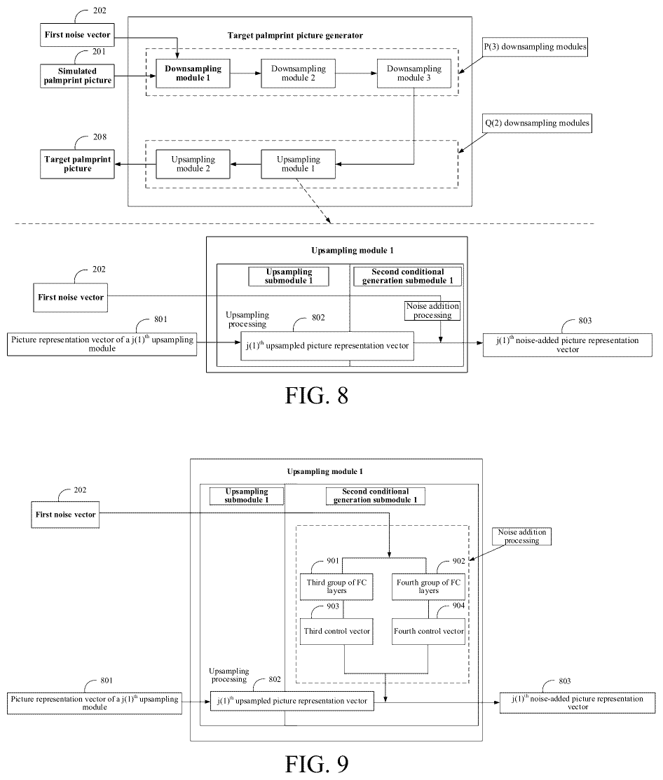

In some embodiments, as shown in FIG. 8, the operation of generating a j(1)^{th} noise-added picture representation vector is described by using a value of j being 1 as an example. The value of j is 1. The upsampling processing is performed on the inputted picture representation vector 801 of the j(1)^{th} upsampling module through the upsampling submodule 1 in the j(1)^{th} upsampling module (the upsampling module 1), to obtain the j(1)^{th} upsampled picture representation vector 802. The second conditional generation submodule 1 in the j(1)^{th} upsampling module performs the noise addition processing on the j(1)^{th} upsampled picture representation vector 802 through the first noise vector 202, to obtain a j(1)^{th} noise-added picture representation vector 803.

In some embodiments, the second conditional generation submodule includes a third group of FC layers and a fourth group of FC layers, and the performing, through the upsampling submodule in a j^{th} upsampling module, the upsampling processing on the picture representation vector inputted into the j^{th} upsampling module, to obtain a j^{th} upsampled picture representation vector includes the following operations.

S71: Pass the first noise vector through the third group of FC layers to output a third control vector, and
pass the first noise vector through the fourth group of FC layers to output a fourth control vector.

S72: Perform, based on the third control vector and the fourth control vector, the noise addition processing on the j^{th} upsampled picture representation vector, to obtain the j^{th} noise-added picture representation vector.

In some embodiments, as shown in FIG. 9, the process of performing, by a second conditional generation submodule, noise addition processing on a picture representation vector is described by using a value of j being 1 as an example. The performing the upsampling processing on the inputted picture representation vector 801 of the j(1)^{th} upsampling module through the upsampling submodule 1 in the j(1)^{th} upsampling module (the upsampling module 1), to obtain the j(1)^{th} upsampled picture representation vector 802 includes: passing the first noise vector 202 through a third group of FC layers 901 in the second conditional generation submodule 1 to obtain a third control vector 903, and passing the first noise vector 202 through a fourth group of FC layers 902 in the second conditional generation submodule 1 to obtain a fourth control vector 904; and performing, based on the third control vector 903 and the fourth control vector 904, the noise addition processing on the j(1)^{th} upsampled picture representation vector 802, to obtain the j(1)^{th} noise-added picture representation vector 803.

In some embodiments, in the embodiments of this application, the structure of the first conditional generation submodule may be the same as the structure of the second conditional generation submodule. With reference to FIG. 7, details are not described herein.

In some embodiments, the performing, based on the third control vector and the fourth control vector, the noise addition processing on the j^{th} upsampled picture representation vector to obtain the j^{th} noise-added picture representation vector further includes the following operations.

S81: Multiply the third control vector by the j^{th} upsampled picture representation vector to obtain a third picture representation vector, and add the third picture representation vector and the fourth control vector together to obtain a fourth picture representation vector, the third control vector being a control vector determined based on a sampling vector, the fourth control vector being a control vector determined based on the sampling vector, and the sampling vector being obtained by sampling the first noise vector.

S82: Determine the fourth picture representation vector as the j^{th} noise-added picture representation vector, or add the fourth picture representation vector and a preset noise vector together to obtain the j^{th} noise-added picture representation vector, the preset noise vector and the sampling vector, and the fourth picture representation vector having the same dimension.

In some embodiments, the foregoing process may be implemented by, but not limited to, the following calculation manner.

X₂ is obtained through the following equation:

$${X}_{2} = {fc}_{1} ( w ( z ) ) {X}_{j} + {fc}_{2} ( w ( z ) )$$

where w(z) is a sampling vector obtained by sampling the first noise vector, fc₁(w(z)) is the third control vector, fc₂(w(z)) is the fourth control vector, and Xⱼ is the j^{th} downsampled picture representation vector.

X₂ is determined as the j^{th} noise-added picture representation vector, or X₂ and the preset noise vector are superimposed to obtain the j^{th} noise-added picture representation vector, the preset noise vector, the sampling vector, and X₂ having the same dimension.

In some embodiments, the process of performing, based on the third control vector and the fourth control vector, the noise addition processing on the j^{th} upsampled picture representation vector to obtain the j^{th} noise-added picture representation vector is similar to the foregoing process of performing, based on the first control vector and the second control vector, the noise addition processing on the i^{th} downsampled picture representation vector to obtain the i^{th} noise-added picture representation vector. Details are not described herein.

In some embodiments, the determining the initial picture representation vector of the simulated palmprint picture based on the simulated palmprint picture further includes the following operation.

S91: Perform first convolution processing on the simulated palmprint picture to obtain the initial picture representation vector.

The generating the target palmprint picture based on the Q^{th} noise-added picture representation vector further includes the following operation.

S92: Perform second convolution processing on the Q^{th} noise-added picture representation vector to obtain the target palmprint picture.

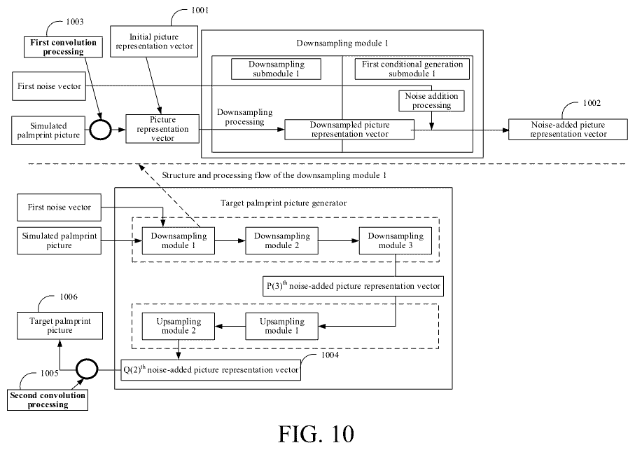

In some embodiments, as shown in FIG. 10, the downsampling module 1, as the first sampling module in the target palmprint picture generator that receives a picture representation vector, receives an initial picture representation vector 1001, and the remaining sampling modules all receive a noise-added picture representation vector 1002 outputted by the previous sampling module. The foregoing initial picture representation vector is 1001 generated based on the simulated palmprint picture, and a specific manner may be performing first convolution processing 1003 on the simulated palmprint picture to obtain the initial picture representation vector.

In addition, a value of Q being 2 is used as an example. A Q(2)^{th} noise-added picture representation vector 1004 outputted by the upsampling module 2 as the last sampling module in the target palmprint picture generator that outputs a picture representation vector is subjected to second convolution processing 1005 to generate a target palmprint picture 1006.

According to some embodiments, the method further includes the following operation.

S101: Perform a plurality of rounds of training on a to-be-trained palmprint picture generator through a group of simulated palmprint sample pictures and a group of first real palmprint pictures, until a target loss value corresponding to the to-be-trained palmprint picture generator satisfies a preset convergence condition; and
determine a palmprint picture generator at the end of training as the target palmprint picture generator,
the to-be-trained palmprint picture generator performing a plurality of downsampling operations and a plurality of upsampling operations on the simulated palmprint sample pictures in sequence during the training, to generate a palmprint picture,
each of the downsampling operations during the training being configured for performing downsampling processing on an inputted picture representation vector to obtain a downsampled picture representation vector, and performing noise addition processing on the downsampled picture representation vector through an intermediate noise vector, to obtain a noise-added picture representation vector,
the picture representation vector inputted in a first downsampling operation during the training being an initial picture representation vector of the simulated palmprint sample pictures, and
the intermediate noise vector being a picture representation vector obtained by encoding each of the first real palmprint pictures, or being a preset noise vector; each of the upsampling operations during the training being configured for performing upsampling processing on an inputted picture representation vector to obtain an upsampled picture representation vector, and performing noise addition processing on the upsampled picture representation vector through an intermediate noise vector, to obtain a noise-added picture representation vector; and
the target loss value being a loss value determined at least based on a first loss value,
the first loss value being a loss value between a generated palmprint picture and the first real palmprint picture, and
the intermediate noise vector being a picture representation vector obtained by encoding the first real palmprint picture when the first loss value is determined.

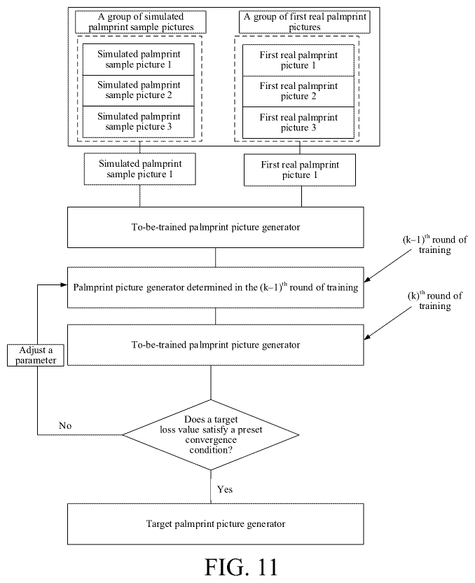

In some embodiments, as shown in FIG. 11, a plurality of rounds of training are performed on a to-be-trained palmprint picture generator through a group of simulated palmprint sample pictures (for example, a simulated palmprint sample picture 1, a simulated palmprint sample picture 2, and a simulated palmprint sample picture 3) and a group of first real palmprint pictures (a first real palmprint picture 1, a first real palmprint picture 2, and a first real palmprint picture 3), until a target loss value corresponding to the to-be-trained palmprint picture generator satisfies a preset convergence condition, and then the training is ended. The to-be-trained palmprint picture generator at the end of training is determine as the target palmprint picture generator, the to-be-trained palmprint picture generator including P to-be-trained downsampling modules and Q to-be-trained upsampling modules.

In some embodiments, the performing a plurality of rounds of training on a to-be-trained palmprint picture generator through a group of simulated palmprint sample pictures and a group of first real palmprint pictures includes the following operation.

S111: Perform a k^{th} round of training on the to-be-trained palmprint picture generator through the following operations, k being a positive integer greater than or equal to 2:
encoding the first real palmprint pictures used in the k^{th} round to obtain a picture representation vector in the k^{th} round;
inputting the picture representation vector in the k^{th} round and the first simulated palmprint sample pictures used in the k^{th} round into a palmprint picture generator obtained after a (k−1)^{th} round of training, to obtain a first palmprint picture generated in the k^{th} round;
determining a first loss value in the k^{th} round based on the first real palmprint pictures used in the k^{th} round and the first palmprint picture generated in the k^{th} round; determining a target loss value in the k^{th} round based on the first loss value in the k^{th} round;
adjusting a parameter in the palmprint picture generator obtained after the (k−1)^{th} round of training when the target loss value in the k^{th} round does not satisfy the convergence condition, to obtain a palmprint picture generator obtained after the k^{th} round of training; and
ending the training when the target loss value in the k^{th} round satisfies the convergence condition.

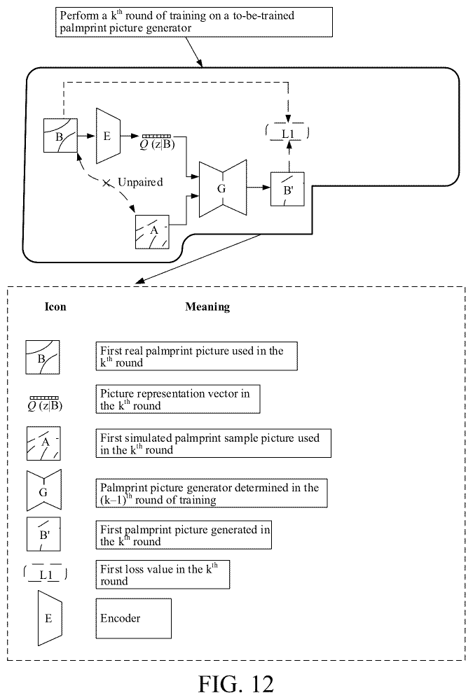

In some embodiments, as shown in FIG. 12, a to-be-trained palmprint picture generator (G) generates a palmprint picture (B′) based on an inputted simulated palmprint sample picture (A) and an inputted first real palmprint picture (B). A first loss value (L1) is a loss value between the palmprint picture (B′) and the first real palmprint picture (B). The foregoing process of generating, by the to-be-trained palmprint picture generator (G), the palmprint picture (B′) based on the inputted simulated palmprint sample picture (A) and the inputted first real palmprint picture (B) may include: passing the first real palmprint picture (B) through an encoder to obtain an encoded picture representation vector Q (z|B) in a k^{th} round, and inputting the picture representation vector and the simulated palmprint sample picture (A) into the to-be-trained palmprint picture generator (G), to obtain the palmprint picture (B′);
performing a k^{th} round of training on the to-be-trained palmprint picture generator through the following operations, k being a positive integer greater than or equal to 2: encoding the first real palmprint picture (B) (an encoder E may be used for encoding) used in the k^{th} round to obtain a picture representation vector (Q(z|B)) in the k^{th} round; inputting the picture representation vector (Q (z|B)) in the k^{th} round and the first simulated palmprint sample picture (A) used in the k^{th} round into a palmprint picture generator (G) obtained after a (k−1)^{th} round of training to obtain a first palmprint picture (B′) generated in the k^{th} round; determining a first loss value (L1) in the k^{th} round based on the first real palmprint picture (B) used in the k^{th} round and the first palmprint picture (B′) generated in the k^{th} round; determining a target loss value in the k^{th} round based on the first loss value (L1) in the k^{th} round; adjusting a parameter in the palmprint picture generator obtained after the (k−1)^{th} round of training in a case that the target loss value in the k^{th} round does not satisfy a preset convergence condition, to obtain a palmprint picture generator obtained after the k^{th} round of training; and ending the training in a case that the target loss value in the k^{th} round satisfies the preset convergence condition.

In some embodiments, the determining a first loss value in the k^{th} round based on the first real palmprint pictures used in the k^{th} round and the first palmprint picture generated in the k^{th} round includes the following operations.

S121: Obtain a pixel difference between pixel values of R pixel points at the same position in the first real palmprint picture used in the k^{th} round and the first palmprint picture generated in the k^{th} round, to obtain R pixel differences, R being a positive integer greater than or equal to 2.

S122: Determine a sum of the R pixel differences as the first loss value in the k^{th} round.

In some embodiments, the foregoing process may be implemented by, but not limited to, the following calculation manner.
L₁ is obtained through the following equation:

$${L}_{1} = {\sum }_{r = 1}^{R} \vert {B}_{r} , {B}_{r}^{′} \vert$$

where Bᵣ is a first pixel value of an r^{th} pixel point of the first real palmprint picture used in the k^{th} round, B′ᵣ is a second pixel value of an r^{th} pixel point of the first palmprint picture generated in the k^{th} round, the first real palmprint picture used in the k^{th} round and the first palmprint picture generated in the k^{th} round both include R pixel points, and |Bᵣ, B′ᵣ| is the similarity between the first pixel value and the second pixel value.
L₁ is determined as the first loss value in the k^{th} round.

In some embodiments, the manner of determining a first loss value in the k^{th} round based on the first real palmprint pictures used in the k^{th} round and the first palmprint picture generated in the k^{h} round is described herein. The first real palmprint picture and the first palmprint picture are both in a picture format. In the foregoing equation of calculating L₁, R represents a quantity of pixel points of each of the first real palmprint picture and the first palmprint picture, Bᵣ is a first pixel value of an r^{th} pixel point of the first real palmprint picture used in the k^{th} round, and B′ᵣ is a second pixel value of the r^{th} pixel point of the first palmprint picture generated in the k^{th} round. The first loss value L₁ is obtained through comparison of the first pixel value and the second pixel value of any two pixel points having a correspondence among the R pixel points.

In some embodiments, the performing a k^{th} round of training on a to-be-trained palmprint picture generator further includes the following operations.

S131: Discriminate the first real palmprint picture used in the k^{th} round and the first palmprint picture generated in the k^{th} round through a trained target discriminator, to obtain a first discrimination result in the k^{th} round, and determine a second loss value in the k^{th} round based on the first discrimination result in the k^{th} round.

In some embodiments, the determining a target loss value in the k^{th} round based on the first loss value in the k^{th} round includes the following operation.

S132: Determine the target loss value in the k^{th} round based on the first loss value in the k^{th} round and the second loss value in the k^{th} round.

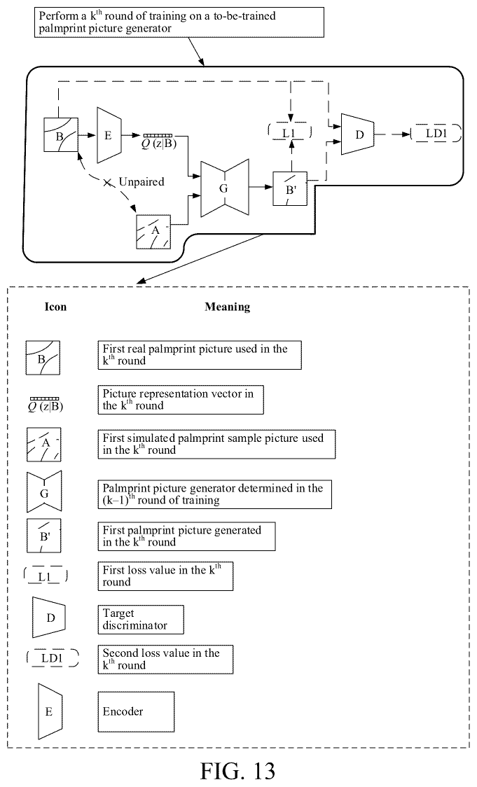

In some embodiments, as shown in FIG. 13, a to-be-trained palmprint picture generator (G) generates a palmprint picture (B′) based on an inputted simulated palmprint sample picture (A) and an inputted first real palmprint picture (B). A first loss value (L1) is a loss value between the palmprint picture (B′) and the first real palmprint picture (B). The inputted first real palmprint picture (B) and the generated palmprint picture (B′) are discriminated through a trained target discriminator (D), to obtain a target discrimination result, and a second loss value (LD1) is a loss value determined based on the target discrimination result. The foregoing process of generating, by the to-be-trained palmprint picture generator (G), the palmprint picture (B′) based on the inputted simulated palmprint sample picture (A) and the inputted first real palmprint picture (B) may include: passing the first real palmprint picture (B) through an encoder to obtain an encoded picture representation vector Q (z|B) in a k^{th} round, and inputting the picture representation vector and the simulated palmprint sample picture (A) into the to-be-trained palmprint picture generator (G), to obtain the palmprint picture (B′);
performing a k^{th} round of training on the to-be-trained palmprint picture generator through the following operations, k being a positive integer greater than or equal to 2: encoding the first real palmprint picture (B) (an encoder E may be used for encoding) used in the k^{th} round to obtain a picture representation vector (Q(z|B)) in the k^{th} round; inputting the picture representation vector (Q (z|B)) in the k^{th} round and the first simulated palmprint sample picture (A) used in the k^{th} round into a palmprint picture generator (G) obtained after a (k−1)^{th} round of training to obtain a first palmprint picture (B′) generated in the k^{th} round; determining a first loss value (L1) in the k^{th} round based on the first real palmprint picture (B) used in the k^{th} round and the first palmprint picture (B′) generated in the k^{th} round; discriminating, through the target discriminator (D), the first real palmprint picture (B) used in the k^{th} round and the first palmprint picture (B′) generated in the k^{th} round, to obtain a first discrimination result in the k^{th} round; determining a second loss value (LD1) in the k^{th} round based on the first discrimination result in the k^{th} round; determining the target loss value in the k^{th} round based on the first loss value (L1) in the k^{th} round and the second loss value (LD1) in the k^{th} round; adjusting a parameter in the palmprint picture generator obtained after the (k−1)^{th} round of training in a case that the target loss value in the k^{th} round does not satisfy a preset convergence condition, to obtain a palmprint picture generator obtained after the k^{th} round of training; and ending the training in a case that the target loss value in the k^{th} round satisfies the preset convergence condition.

In some embodiments, the determining a second loss value in the k^{th} round based on the first discrimination result in the k^{th} round includes the following operations.

S141: Obtain a probability that the first real palmprint picture used in the k^{t}h round indicated by the first discrimination result is true, to obtain a first probability, and obtain a probability that the first palmprint picture generated in the k^{th} round indicated by the first discrimination result is true, to obtain a second probability.

S142: Multiply the first probability by a probability at the same position in the second probability to obtain a first probability product.

S143: Obtain a probability that the first palmprint picture generated in the k^{th} round indicated by the first discrimination result is false, to obtain a third probability, and obtain a probability that the first real palmprint picture used in the k^{th} round indicated by the first discrimination result is false, to obtain a fourth probability.

S144: Multiply the third probability by a probability at the same position in the fourth probability to obtain a second probability product.

S145: Determine a second loss value in the k^{th} round based on the first probability product and the second probability product.

In some embodiments, the foregoing process may be implemented by, but not limited to, one of the following calculation manners.

### Calculation Manner I:

L_{D1} is obtained through the following equation:

$${L}_{D1} = - {y}_{t} log D ( {x}_{t} ) - ( 1 - {y}_{t} ) log ( 1 - D ( {x}_{t} ) )$$

where log D(xₜ) is a probability that the first real palmprint picture used in the k^{th} round indicated by the first discrimination result is true, log(1−D(xₜ)) is a probability that the first real palmprint picture used in the k^{th} round indicated by the first discrimination result is false, yₜ is a probability that the first palmprint picture generated in the k^{th} round indicated by the first discrimination result is true, and (1−yₜ) is a probability that the first palmprint picture generated in the k^{th} round indicated by the first discrimination result is false.

L_{D1} is determined as the second loss value in the k^{th} round.

### Calculation Manner II:

L_{D1} is obtained through the following equation:

$${L}_{D 1} = - {\sum }_{t = 1}^{N 1} {y}_{t} log D ( {x}_{t} ) - {\sum }_{t = 1}^{N 1} ( 1 - {y}_{t} ) log ( 1 - D ( {x}_{t} ) )$$

where log D(xₜ) is a probability that a t^{th} first real palmprint picture in N1 first real palmprint pictures used in the k^{th} round indicated by the first discrimination result is true, log(1−D(xₜ)) is a probability that a t^{th} first real palmprint picture in N1 first real palmprint pictures used in the k^{th} round indicated by the first discrimination result is false, yₜ is a probability that a t^{th} first palmprint picture in N1 first palmprint pictures generated in the k^{th} round indicated by the first discrimination result is true, and (1−yₜ) is a probability that a t^{th} first palmprint picture in N1 first palmprint pictures generated in the k^{th} round indicated by the first discrimination result is false.

L_{D1} is determined as the second loss value in the k^{th} round.

In some embodiments, the target discriminator is first described. The target discriminator may discriminate an inputted palmprint picture, and determine whether the picture is a true picture or a false picture. The foregoing real picture may mean that the target discriminator considers that the picture is a true picture collected in the real world, for example, a truly collected palmprint picture. On the contrary, a false picture may mean that the target discriminator considers that the picture is not a true picture collected in the real world, but a picture synthesized through technical means.

In some embodiments, training of a palmprint picture generator is the key. A to-be-trained palmprint picture generator is trained. When a palmprint picture generated by the to-be-trained palmprint picture generator is inputted into a target discriminator, the target discriminator determines that the palmprint picture is a true picture, which indicates that the palmprint picture generated by the to-be-trained palmprint picture generator in this case may be “realistic”, and then the to-be-trained palmprint picture generator in this case may be determined as a target palmprint picture generator.

In some embodiments, the foregoing probability of being true may be understood as a probability that the target discriminator determines that the palmprint picture is a true picture, and the foregoing probability of being false may be understood as a probability that the target discriminator determines that the palmprint picture is a false picture.

In some embodiments, the first discrimination result in the k^{th} round may include, but is not limited to, performing discrimination through N1 first real palmprint pictures and N1 first palmprint pictures by the target discriminator. The foregoing discrimination process may be performed in parallel through a plurality of processes.

In some embodiments, the performing a k^{th} round of training on a to-be-trained palmprint picture generator further includes the following operation.

S151: Input a noise vector in the k^{th} round and a first simulated palmprint sample picture used in the k^{th} round into a palmprint picture generator obtained after the (k−1)^{th} round of training, to obtain a second palmprint picture generated in the k^{th} round, and determine a third loss value in the k^{th} round based on the first palmprint picture generated in the k^{th} round and the second palmprint picture generated in the k^{th} round.

The determining the target loss value in the k^{th} round based on the first loss value in the k^{th} round and the second loss value in the k^{th} round further includes the following operation.

S152: Determine the target loss value in the k^{th} round based on the first loss value in the k^{th} round, the second loss value in the k^{th} round, and the third loss value in the k^{th} round.

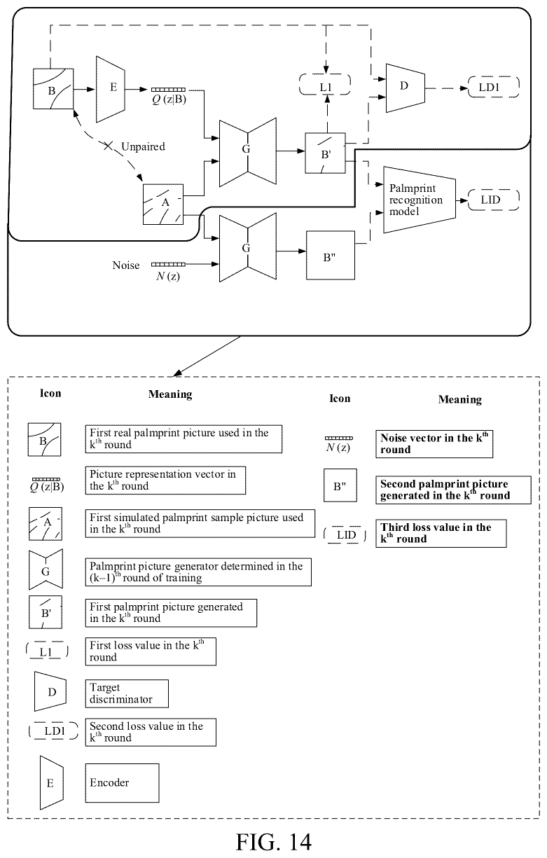

In some embodiments, for the manner of generating the first loss value and the second loss value, reference may be made to the description in FIG. 13 above, and the details are not described herein. Only the manner of determining the third loss value is described herein. As shown in FIG. 14, a noise vector (N(z)) in the k^{th} round and a first simulated palmprint sample picture (A) used in the k^{th} round are inputted into a palmprint picture generator (G) obtained after the (k−1)^{th} round of training, to obtain a second palmprint picture (B″) generated in the k^{th} round, and a third loss value (LID) in the k^{th} round is determined based on the first palmprint picture (B′) generated in the k^{th} round and the second palmprint picture (B″) generated in the k^{th} round.

The manner of determining the third loss value (LID) in the k^{th} round based on the first palmprint picture (B′) generated in the k^{th} round and the second palmprint picture (B″) generated in the k^{th} round may be, but is not limited to: inputting the first palmprint picture (B′) and the second palmprint picture (B″) into a palmprint recognition network (palmprint recognition model), extracting feature vectors of the first palmprint picture (B′) and the second palmprint picture (B″) respectively, and then determining the third loss value (LID) in the k^{th} round based on the feature vectors thereof.

In some embodiments, the determining a third loss value in the k^{th} round based on the first palmprint picture generated in the k^{th} round and the second palmprint picture generated in the k^{th} round further includes the following operations.

S161: Perform vector dot product on a first feature vector of the first palmprint picture generated in the k^{th} round and a second feature vector of the second palmprint picture generated in the k^{th} round, to obtain a vector dot product value.

S162: Multiply a modulus of the first feature vector by a modulus of the second feature vector to obtain a product value.

S163: Divide the vector dot product value by the product value to obtain a target ratio, and subtract the target ratio from 1 to obtain the third loss value in the k^{th} round.

In some embodiments, the foregoing process may be implemented by, but not limited to, the following calculation manner.

L_{ID} is obtained through the following equation:

$${L}_{ID} = 1 - \frac{{D}_{MB} ( {B}^{′} ) \cdot {D}_{MB} ( {B}^{″} )}{‖ {D}_{MB} ( {B}^{′} ) ‖ * ‖ {D}_{MB} ( {B}^{″} ) ‖}$$

where D_{MB}(B′) is the first feature vector of the first palmprint picture generated in the k^{th} round, D_{MB}(B″) is the second feature vector of the second palmprint picture generated in the k^{th} round, D_{MB}(B′)−D_{MB}(B″) is a dot product of the first feature vector and the second feature vector, ∥ID_{MB}(B′)∥ is the modulus of the first feature vector, and ∥D_{MB}(B″)∥ is the modulus of the second feature vector.

L_{ID} is determined as the third loss value in the k^{th} round.

In some embodiments, the first palmprint picture (B′) generated in the k^{th} round and the second palmprint picture (B″) generated in the k^{th} round are inputted into a palmprint recognition network (palmprint recognition model), and the first feature vector D_{MB}(B′) of the first palmprint picture (B′) and the second feature vector D_{MB}(B″) of the second palmprint picture (B″) are respectively extracted, and then the third loss value (LID) in the k^{th} round is calculated based on the foregoing equation. The following is an example of the calculation process.

For example, D_{MB}(B′) is (a₁, a₂, a₃), D_{MB}(B″) is (b₁, b₂, b₃), and then

$${L}_{ID} = 1 - \frac{{a}_{1} {b}_{1} + {a}_{2} {b}_{2} + {a}_{3} {b}_{3}}{\sqrt{{a}_{1}^{2} + {a}_{2}^{2} + {a}_{3}^{2}} * \sqrt{{b}_{1}^{2} + {b}_{2}^{2} + {b}_{3}^{2}}}$$

In some embodiments, the performing a k^{th} round of training on a to-be-trained palmprint picture generator further includes the following operation.

S171: Determine a fourth loss value in the k^{th} round based on the noise vector in the k^{th} round and the picture representation vector in the k^{th} round.

The determining the target loss value in the k^{th} round based on the first loss value in the k^{th} round, the second loss value in the k^{th} round, and the third loss value in the k^{th} round further includes the following operation.

S172: Determine the target loss value in the k^{th} round based on the first loss value in the k^{th} round, the second loss value in the k^{th} round, the third loss value in the k^{th} round, and the fourth loss value in the k^{t}h round.

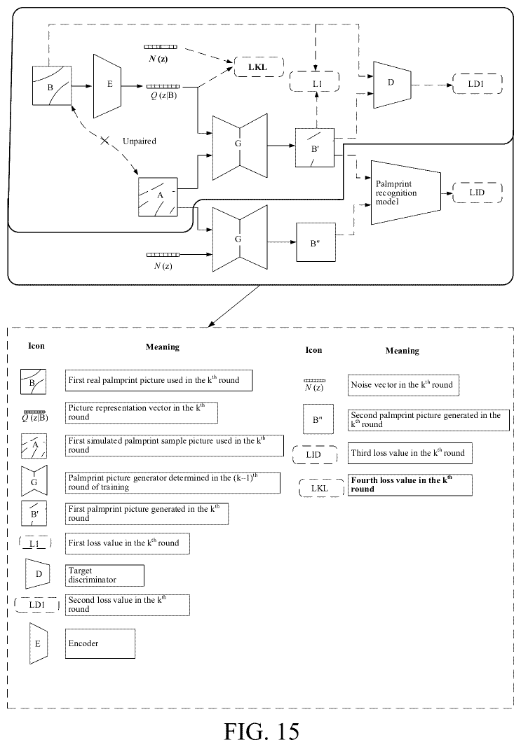

In some embodiments, for the manner of generating the first loss value, the second loss value, and the third loss value, reference may be made to the descriptions in FIG. 13 and FIG. 14 above, and the details are not described herein. Only the manner of determining the fourth loss value is described herein. As shown in FIG. 15, a fourth loss value (LKL) in the k^{th} round is determined based on the noise vector (N(z)) in the k^{th} round and the picture representation vector (Q(z|B)) in the k^{th} round. The fourth loss value (LKL) may constrain the picture representation vector (Q(z|B)) in the k^{th} round, and constrain distribution consistency with the noise vector (N(z)) in the k^{th} round. The noise vector (N(z)) in the k^{th} round may be, but is not limited to, original Gaussian noise, namely white noise.

In some embodiments, the determining a fourth loss value in the k^{th} round based on the noise vector in the k^{th} round and the picture representation vector in the k^{th} round further includes the following operations.

S181: Obtain a value of each dimension in the picture representation vector in the k^{th} round, and obtain a value of each dimension in the noise vector in the k^{h} round, the picture representation vector in the k^{th} round having the same total dimension as the noise vector in the k^{th} round.

S182: Determine the fourth loss value in the k^{th} round based on the value of each dimension in the picture representation vector in the k^{th} round and the value of each dimension in the noise vector in the k^{th} round.

In some embodiments, the foregoing process may be implemented by, but not limited to, the following calculation manner.

L_{KL} is obtained through the following equation:

$${L}_{KL} = {\sum }_{m = 1}^{M} Q ( {z}_{m} ) * log \frac{Q ( {z}_{m} )}{N ( {z}_{m} )}$$

where Q(zₘ) is a value of an m^{th} dimension in the picture representation vector in the k^{th} round, N(zₘ) is a value of an m^{th} dimension in the noise vector in the k^{th} round, and the total dimensions of the picture representation vector in the k^{th} round and the noise vector in the k^{th} round are both M.

L_{KL} is determined as the fourth loss value in the k^{th} round.

In some embodiments, the following is an example of a calculation process of L_{KL}.

A value of M being 8 and a value of m being 3 are used as an example. For example, the total dimensions of the picture representation vector in the k^{th} round and the noise vector in the k^{th} round are both 8, the picture representation vector in the k^{th} round is (c1, c2, c3, c4, c5, c6, c7, and c8), and the noise vector in the k^{th} round is (d1, d2, d3, d4, d5, d6, d7, and d8), and then the value of Q(z₃) is c3, and the value of N(z₃) is d3, which are substituted into the foregoing equation for calculation. In this way, 8-dimensional data is summed to obtain the fourth loss value L_{KL}.

In some embodiments, the performing a k^{th} round of training on a to-be-trained palmprint picture generator further includes the following operations.

S191: Discriminate, through the target discriminator, the second real palmprint picture used in the k^{th} round and the second palmprint picture generated in the k^{th} round, to obtain a second discrimination result in the k^{th} round, and determine a fifth loss value in the k^{th} round based on the second discrimination result in the k^{th} round.

The determining the target loss value in the k^{th} round based on the first loss value in the k^{th} round, the second loss value in the k^{th} round, the third loss value in the k^{th} round, and the fourth loss value in the k^{th} round further includes the following operation.

S192: Determine the target loss value in the k^{th} round based on the first loss value in the k^{th} round, the second loss value in the k^{th} round, the third loss value in the k^{th} round, the fourth loss value in the k^{th} round, and the fifth loss value in the k^{th} round.

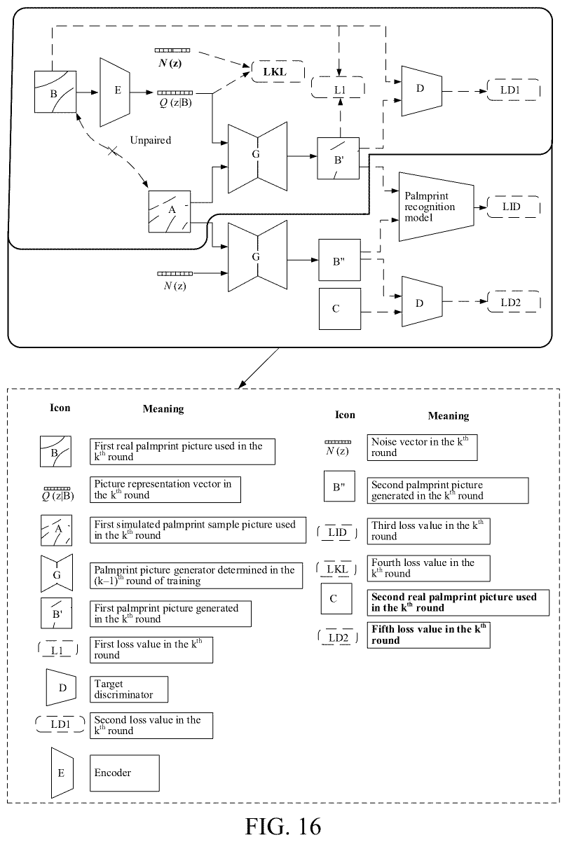

In some embodiments, for the manner of generating the first loss value, the second loss value, the third loss value, and the fourth loss value, reference may be made to the descriptions in FIG. 13, FIG. 14, and FIG. 15 above, and the details are not described herein. Only the manner of determining the fifth loss value is described herein. As shown in FIG. 16, a second real palmprint picture (C) used in the k^{th} round and a second palmprint picture (B″) generated in the k^{th} round are discriminated through the target discriminator (D), to obtain a second discrimination result in the k^{th} round, and a fifth loss value (LD2) in the k^{th} round is determined based on the second discrimination result in the k^{th} round.

In some embodiments, the second real palmprint picture (C) used in the k^{th} round and the first real palmprint picture used in the k^{th} round respectively belong to real palmprint pictures of two different persons. To be specific, the two persons have different palmprint features.

In some embodiments, the determining a fifth loss value in the k^{th} round based on the second discrimination result in the k^{th} round further includes the following operations.

S201: Obtain a probability that the second real palmprint picture used in the k^{th} round indicated by the second discrimination result is true, to obtain a fifth probability, and obtain a probability that the second palmprint picture generated in the k^{th} round indicated by the second discrimination result is true, to obtain a sixth probability.

S202: Multiply the fifth probability by a probability at the same position in the sixth probability to obtain a third probability product.

S203: Obtain a probability that the second real palmprint picture used in the k^{th} round indicated by the second discrimination result is false, to obtain a seventh probability, and obtain a probability that the second palmprint picture generated in the k^{th} round indicated by the second discrimination result is false, to obtain an eighth probability.

S204: Multiply the seventh probability by a probability at the same position in the eighth probability to obtain a fourth probability product.

S205: Determine a fifth loss value in the k^{th} round based on the third probability product and the fourth probability product.

In some embodiments, the foregoing process may be implemented by, but not limited to, one of the following calculation manners.

### Calculation Manner I:

L_{D2} is obtained through the following equation:

$${L}_{D 2} = - {y}_{v} log D ( {x}_{v} ) - ( 1 - {y}_{v} ) log ( 1 - D ( {x}_{v} ) )$$

where log D(xᵥ) is a probability that the second real palmprint picture used in the k^{th} round indicated by the second discrimination result is true, log(1−D(xᵥ)) is a probability that the second real palmprint picture used in the k^{th} round indicated by the second discrimination result is false, yᵥ is a probability that the second palmprint picture generated in the k^{th} round indicated by the second discrimination result is true, and (1−yᵥ) is a probability that the second palmprint picture generated in the k^{th} round indicated by the second discrimination result is false.

L_{D2} is determined as the fifth loss value in the k^{th} round.

### Calculation Manner II:

L_{D2} is obtained through the following equation:

$${L}_{D 2} = - {\sum }_{v = 1}^{N 2} {y}_{v} log D ( {x}_{v} ) - {\sum }_{v = 1}^{N 2} ( 1 - {y}_{v} ) log ( 1 - D ( {x}_{v} ) )$$

where log D(xᵥ) is a probability that a v^{th} second real palmprint picture in N2 second real palmprint pictures used in the k^{th} round indicated by the second discrimination result is true, log(1−D(xᵥ)) is a probability that a v^{th} second real palmprint picture in N2 second real palmprint pictures used in the k^{th} round indicated by the second discrimination result is false, yᵥ is a probability that a v^{th} second palmprint picture in N2 second palmprint pictures generated in the k^{th} round indicated by the second discrimination result is true, and (1−yᵥ) is a probability that a v^{th} second palmprint picture in N2 second palmprint pictures generated in the k^{th} round indicated by the second discrimination result is false.

L_{D2} is determined as the fifth loss value in the k^{th} round.

In some embodiments, the calculation process of the fifth loss value L_{D2} is similar to that of the second loss value L_{D1}, and the fifth loss value L_{D2} may be calculated by referring to the calculation manner of the second loss value L_{D1} described above. Details are not described herein.

In some embodiments, the method further includes the following operation.

S212: Train a to-be-trained palmprint picture matching model through a set of palmprint pictures, to obtain a target palmprint picture matching model,
the set of palmprint pictures including the target palmprint picture and another palmprint picture, the another palmprint picture being generated in the same manner as the target palmprint picture; and
the target palmprint picture matching model being configured to match an inputted group of palmprint pictures, the group of palmprint pictures including a to-be-confirmed palmprint picture and a collected palmprint picture.

In some embodiments, palmprint pictures except the target palmprint picture in the set of palmprint pictures are the palmprint pictures generated in the same generation manner as that of the target palmprint picture. The generation manner may be, but is not limited to, outputting palmprint pictures of different modalities as the set of palmprint pictures by adjusting parameters of the same conditional generation submodules in P downsampling modules and Q upsampling modules. Palmprint line features of any two palmprint pictures in one set of palmprint pictures are consistent, which are all taken from simulated palmprint curves in a simulated palmprint picture. Since the parameters of the conditional generation submodules are different in each generation process, the outputted modalities may be different.

In some embodiments, the method further includes the following operations.

S222: Combine Bezier curves to obtain the simulated palmprint curve, the curves of the target type including the Bezier curves.

S223: Generate the simulated palmprint picture including the simulated palmprint curve.

In some embodiments, the simulated palmprint picture includes the simulated palmprint curve obtained by combining the curves of the target type. The curves of the target type may be, but are not limited to, the Bezier curves, and the combination of the curves of the target type may be, but is not limited to, a free combination of a plurality of Bezier curves, or an arrangement and combination according to a rule similar to that of palmprint features.

Some embodiments provide a palmprint picture generation method, which may be understood as a multi-modal palmprint generation method. A conditional generation submodule is added to each module of a generative adversarial network to enhance the ability of a model to learn diverse samples. Palmprint sample pictures of different modalities may be generated simultaneously by controlling conditional probability, thereby implementing the multi-modal palmprint generation ability of a visible light modality and an infrared modality. A palmprint picture matching model is trained through the generated palmprint sample pictures, to enhance a fitting effect of the palmprint picture matching model for images of different modalities. In addition, a twin ID protection module is added to maintain consistency of palmprint lines of the same ID.

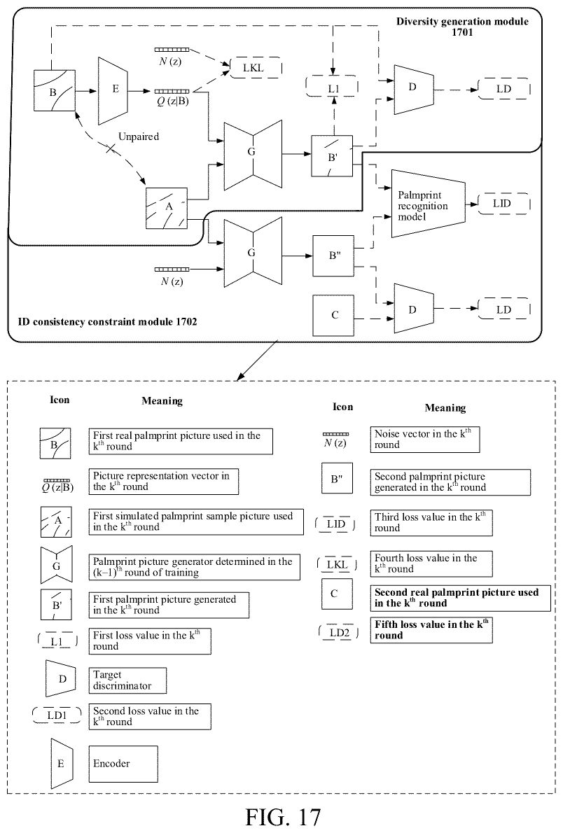

As shown in FIG. 17, two modules are mainly included:
one is a diversity generation module 1701, configured to increase intra-class diversity of generated samples, and
the other is an ID consistency constraint module 1702, configured to control intra-class ID consistency of samples.

For a simulated image B′(which may be understood as the foregoing first palmprint picture) generated by a palmprint picture generator, L1 is calculated through a real palmprint image B (which may be understood as the foregoing first real palmprint picture) to constrain authenticity of skin and muscle texture of the generated B′. To constrain Q(z|B), a KL divergence between Q(z|B) and N(z) is calculated as a loss function, to constrain distribution consistency of Q(z|B) and N(z). The obtained B′ and B are inputted into a target discriminator D, and the target discriminator includes three convolutional neural network layers. The discriminator extracts features of B′ and B, and then optimizes the authenticity of the generated B′ through adversarial loss.

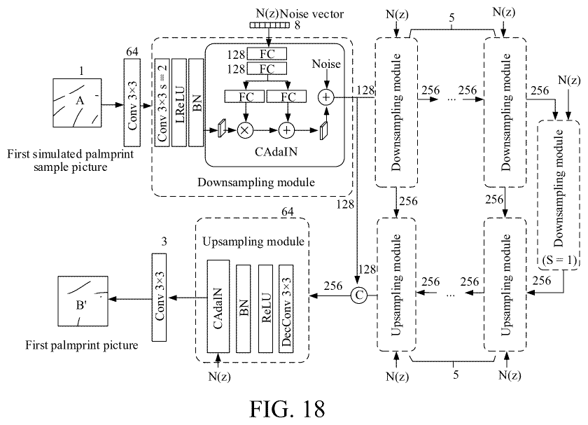

To increase the diversity of generated samples, a conditional generation submodule is designed to enhance the diversity of generated samples. As shown in FIG. 18,
the overall structure of the target palmprint picture generator may be composed of 7 downsampling modules and 6 upsampling modules. Each downsampling module and each upsampling module respectively includes a conditional generation submodule CAdaIN.

### I. Diversity Generation Module

Training stage: The diversity generation module firstly maps a real palmprint image B to a Gaussian noise domain vector Q(z|B) (which may be understood as the foregoing picture representation vector) through an encoder E, and a generator G (which may be understood as the foregoing palmprint picture generator) remaps the encoded noise domain vector Q(z|B) to a palmprint image domain by using an unpaired Bezier palmprint line A (which may be understood as the foregoing first simulated palmprint picture) as a condition. The Bezier palmprint line A is a palmprint-like curve formed by combining different Bezier curves.

Reasoning stage: A self-defined Bezier palmprint line A and Q(z|B) are inputted into the generator G to generate palmprint samples of different modalities (which may be understood as the foregoing target palmprint picture).

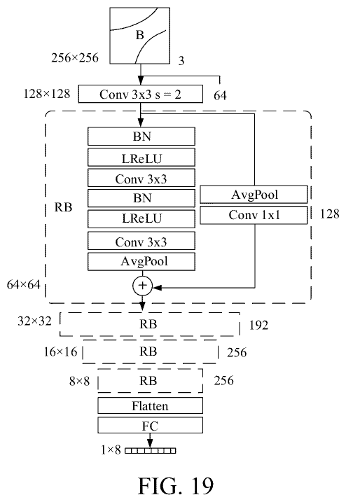

As shown in FIG. 19, the structure of the encoder E is composed of 4 residual blocks (RB) and 1 FC layer. In the figure, BN represents a batch normalization layer, LReLU represents a leakyReLU layer, conv represents a convolutional layer, avgpool represents an average pooling layer, FC represents an FC layer, and Flatten is a function for flattening a multidimensional array into a one-dimensional array.

### II. ID Consistency Constraint Module

To ensure the intra-class ID consistency of generated simulated palms, an ID consistency constraint module is provided. The module uses a twin structure. For the same inputted Bezier palmprint line A, a new random control hidden vector N(z) is inputted into the generator G to generate a new simulated palmprint B″. B′ and B″ are respectively inputted into a trained palmprint feature extraction model based on a real palmprint image to extract a 512-dimensional feature vector. A cosine similarity of B′ and B″ is calculated based on the extracted feature vector, and consistency of intra-class samples is constrained through the LID.

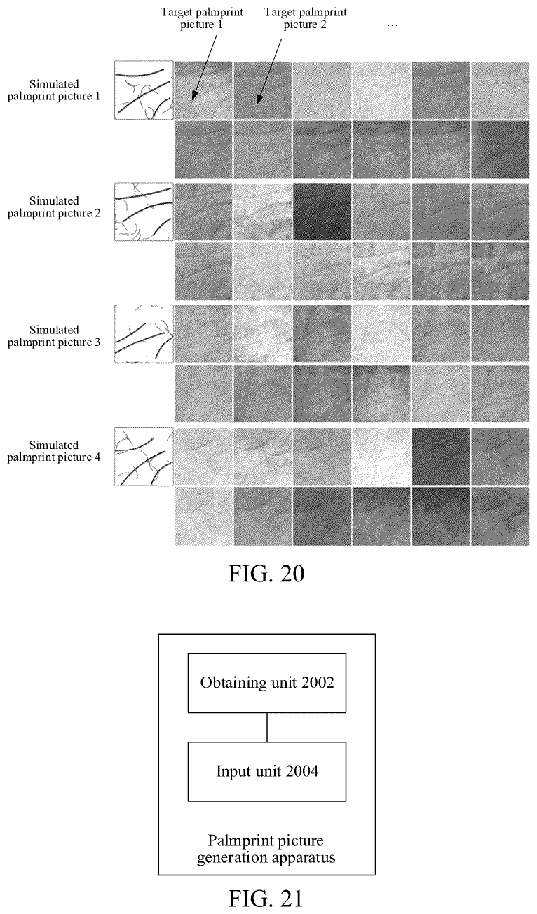

Through the palmprint picture generation method provided in some embodiments, palmprint effect pictures of different modalities generated by a single Bezier curve (which may be understood as the foregoing simulated palmprint picture) may be used, and palms of various modalities (which may be understood as the foregoing target palmprint pictures) may be generated by adjusting the inputted random noise (N(z)), including various visible light and infrared black and white images. As shown in FIG. 20, through the palmprint picture generation method, target palmprint pictures of different modalities may be generated based on a single simulated palmprint picture. For example, through a simulated palmprint picture 1, a simulated palmprint picture 2, a simulated palmprint picture 3, and a simulated palmprint picture 4, 12 target palmprint pictures may be generated. The simulated palmprint picture 1 is used as an example. After a target palmprint picture 1 is generated through the simulated palmprint picture 1 and a first noise vector, another first noise vector may be inputted, or the first noise vector is adjusted to output a target palmprint picture 2 with a different modality from the target palmprint picture 1, but with consistent palmprint lines (all are consistent with the simulated palmprint picture 1), and so on, so as to generate more target palmprint pictures of other modalities. Effectiveness of the provided CAdaIN module is verified. In addition, palmprint lines generated under a single Bezier curve are consistent, and no extra palms appear. Effectiveness of the provided ID consistency constraint module is demonstrated.

For brevity, the foregoing method embodiments are described as a series of action combinations. However, it is to be appreciated by a person skilled in the art that this application is not limited to the described sequence of the actions, because some operations may be performed in another sequence or simultaneously according to this application. In addition, a person skilled in the art also needs to know that the embodiments described in the specification are all preferred embodiments, and the involved actions and modules are not necessary for this application.

According to some embodiments, a palmprint picture generation apparatus for implementing the foregoing palmprint picture generation method is further provided. FIG. 21 is a structural block diagram of a palmprint picture generation apparatus according to some embodiments. As shown in FIG. 21, the apparatus includes:
an obtaining unit 2002, configured to obtain a simulated palmprint picture, the simulated palmprint picture including a simulated palmprint curve obtained by combining curves of a target type; and
an input unit 2004, configured to input the simulated palmprint picture and a preset first noise vector into a trained target palmprint picture generator, and perform a plurality of downsampling operations and a plurality of upsampling operations on the simulated palmprint picture in sequence through the target palmprint picture generator, to generate a target palmprint picture,
each of the downsampling operations being configured for performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and
each of the upsampling operations being configured for performing upsampling processing on the inputted picture representation vector to obtain an upsampled picture representation vector, and performing noise addition processing on the upsampled picture representation vector through the first noise vector, to obtain a noise-added picture representation vector.

In some embodiments, the input unit includes:
a determining module, configured to determine the initial picture representation vector based on the simulated palmprint picture;
a first sampling module, configured to perform the downsampling operation on the initial picture representation vector through the P downsampling modules in sequence, to obtain a P^{th} noise-added picture representation vector, each of the P downsampling modules including a downsampling submodule and a first conditional generation submodule,
the downsampling submodule being configured to perform the downsampling processing on the inputted picture representation vector, to obtain a downsampled picture representation vector, and
the first conditional generation submodule being configured to perform noise addition processing on the downsampled picture representation vector through the first noise vector, to obtain a noise-added picture representation vector;
a second sampling module, configured to perform the upsampling operation on the P^{th} noise-added picture representation vector through the Q upsampling modules in sequence, to obtain a Q^{th} noise-added picture representation vector, each of the Q upsampling modules including an upsampling submodule and a second conditional generation submodule,
the upsampling submodule being configured to perform the upsampling processing on the inputted picture representation vector to obtain an upsampled picture representation vector, and
the second conditional generation submodule being configured to perform the noise addition processing on the upsampled picture representation vector through the first noise vector, to obtain a noise-added picture representation vector; and
a determining module, configured to generate the target palmprint picture based on the Q^{th} noise-added picture representation vector.

In some embodiments, the first sampling module is further configured to:
obtain an i^{th} noise-added picture representation vector through the following operations, i being a positive integer greater than or equal to 1 and less than or equal to P;
perform, through the downsampling submodule in an i^{th} downsampling module, the downsampling processing on the picture representation vector inputted into the i^{th} downsampling module, to obtain an i^{th} downsampled picture representation vector; and
perform, through the first conditional generation submodule in the i^{th} downsampling module, the noise addition processing on the i^{th} downsampled picture representation vector by using the first noise vector, to obtain an i^{th} noise-added picture representation vector.

In some embodiments, the first conditional generation submodule includes a first group of FC layers and a second group of FC layers. The first sampling module is configured to:
pass the first noise vector through the first group of FC layers to output a first control vector;
pass the first noise vector through the second group of FC layers to output a second control vector; and
perform, based on the first control vector and the second control vector, the noise addition processing on the i^{th} downsampled picture representation vector, to obtain the i^{th} noise-added picture representation vector.

In some embodiments, the second sampling module is configured to:
obtain a j^{th} noise-added picture representation vector through the following operations, j being a positive integer greater than or equal to 1 and less than or equal to Q:
performing, through the upsampling submodule in a j^{th} upsampling module, the upsampling processing on the picture representation vector inputted into the j^{th} upsampling module, to obtain a j^{th} upsampled picture representation vector; and
performing, through the second conditional generation submodule in the j^{th} upsampling module, the noise addition processing on the j^{th} upsampled picture representation vector by using the first noise vector, to obtain a j^{th} noise-added picture representation vector.

In some embodiments, the second conditional generation submodule includes a third group of FC layers and a fourth group of FC layers. The second sampling module is configured to:
pass the first noise vector through the third group of FC layers to output a third control vector;
pass the first noise vector through the fourth group of FC layers to output a fourth control vector; and
perform, based on the third control vector and the fourth control vector, the noise addition processing on the j^{th} upsampled picture representation vector, to obtain the j^{th} noise-added picture representation vector.

In some embodiments, the determining module is configured to perform first convolution processing on the simulated palmprint picture to obtain the initial picture representation vector.

The determining module is configured to perform second convolution processing on the Q^{th} noise-added picture representation vector to obtain the target palmprint picture.

In some embodiments, the apparatus further includes:
a first training unit, configured to perform a plurality of rounds of training on a to-be-trained palmprint picture generator through a group of simulated palmprint sample pictures and a group of first real palmprint pictures, until a target loss value corresponding to the to-be-trained palmprint picture generator satisfies a preset convergence condition; and
determine a palmprint picture generator at the end of training as the target palmprint picture generator,
the to-be-trained palmprint picture generator performing a plurality of downsampling operations and a plurality of upsampling operations on the simulated palmprint sample pictures in sequence during the training, to generate a palmprint picture,
each of the downsampling operations during the training being configured for performing downsampling processing on an inputted picture representation vector to obtain a downsampled picture representation vector, and performing noise addition processing on the downsampled picture representation vector through an intermediate noise vector, to obtain a noise-added picture representation vector,
the picture representation vector inputted in a first downsampling operation during the training being an initial picture representation vector of the simulated palmprint sample pictures, and
the intermediate noise vector being a picture representation vector obtained by encoding each of the first real palmprint pictures, or being a preset noise vector;
each of the upsampling operations during the training being configured for performing upsampling processing on an inputted picture representation vector to obtain an upsampled picture representation vector, and performing noise addition processing on the upsampled picture representation vector through an intermediate noise vector, to obtain a noise-added picture representation vector; and
the target loss value being a loss value determined at least based on a first loss value,
the first loss value being a loss value between a generated palmprint picture and the first real palmprint picture, and
the intermediate noise vector being a picture representation vector obtained by encoding the first real palmprint picture when the first loss value is determined.

In some embodiments, the first training unit includes:
a training module, configured to perform a k^{th} round of training on the to-be-trained palmprint picture generator through the following operations, k being a positive integer greater than or equal to 2:
encoding the first real palmprint pictures used in the k^{th} round to obtain a picture representation vector in the k^{th} round;
inputting the picture representation vector in the k^{th} round and the first simulated palmprint sample pictures used in the k^{th} round into a palmprint picture generator obtained after a (k−1)^{th} round of training, to obtain a first palmprint picture generated in the k^{th} round;
determining a first loss value in the k^{th} round based on the first real palmprint pictures used in the k^{th} round and the first palmprint picture generated in the k^{th} round; determining a target loss value in the k^{th} round based on the first loss value in the k^{th} round;
adjusting a parameter in the palmprint picture generator obtained after the (k−1)^{th} round of training when the target loss value in the k^{th} round does not satisfy the convergence condition, to obtain a palmprint picture generator obtained after the k^{th} round of training; and
ending the training when the target loss value in the k^{th} round satisfies the convergence condition.

In some embodiments, the training module is further configured to: discriminate, through a trained target discriminator, the first real palmprint pictures used in the k^{th} round and the first palmprint picture generated in the k^{th} round, to obtain a first discrimination result in the k^{th} round; and determine a second loss value in the k^{th} round based on the first discrimination result in the k^{th} round.

The training module is further configured to determine the target loss value in the k^{th} round based on the first loss value in the k^{th} round and the second loss value in the k^{th} round.

In some embodiments, the training module is further configured to: input a noise vector in the k^{th} round and the first simulated palmprint sample pictures used in the k^{th} round into the palmprint picture generator obtained after the (k−1)^{th} round of training to obtain a second palmprint picture generated in the k^{th} round; and determine a third loss value in the k^{th} round based on the first palmprint picture generated in the k^{th} round and the second palmprint picture generated in the k^{th} round.

The training module is further configured to determine the target loss value in the k^{th} round based on the first loss value in the k^{th} round, the second loss value in the k^{th} round, and the third loss value in the k^{th} round.

In some embodiments, the training module is further configured to determine a fourth loss value in the k^{th} round based on the noise vector in the k^{th} round and the picture representation vector in the k^{th} round.

The training module is further configured to determine the target loss value in the k^{th} round based on the first loss value in the k^{th} round, the second loss value in the k^{th} round, the third loss value in the k^{th} round, and the fourth loss value in the k^{th} round.

In some embodiments, the training module is further configured to: discriminate, through the target discriminator, a second real palmprint picture used in the k^{th} round and the second palmprint picture generated in the k^{th} round, to obtain a second discrimination result in the k^{th} round; and determine a fifth loss value in the k^{th} round based on the second discrimination result in the k^{th} round.

The training module is further configured to determine the target loss value in the k^{th} round based on the first loss value in the k^{th} round, the second loss value in the k^{th} round, the third loss value in the k^{th} round, the fourth loss value in the k^{th} round, and the fifth loss value in the k^{th} round.

In some embodiments, the apparatus further includes:
a second training unit, configured to
train a to-be-trained palmprint picture matching model through a set of palmprint pictures, to obtain a target palmprint picture matching model,
the set of palmprint pictures including the target palmprint picture and another palmprint picture, the another palmprint picture being generated in the same manner as the target palmprint picture; and
the target palmprint picture matching model being configured to match an inputted group of palmprint pictures, the group of palmprint pictures including a to-be-confirmed palmprint picture and a collected palmprint picture.

In some embodiments, the apparatus further includes:
a combining unit, configured to combine Bezier curves to obtain the simulated palmprint curve, the curves of the target type including the Bezier curves; and
a generating unit, configured to generate the simulated palmprint picture including the simulated palmprint curve.

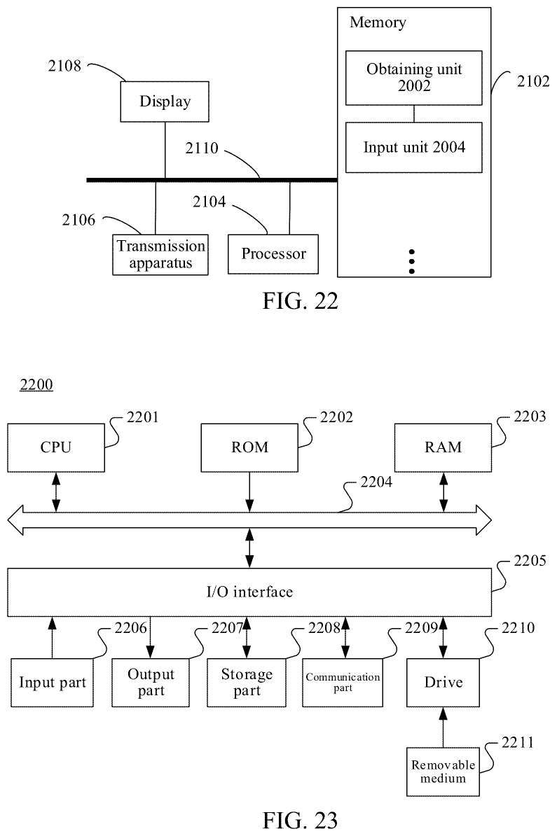

According to some embodiments, an electronic device for implementing the foregoing palmprint picture generation method is further provided. The electronic device may be a terminal device or a server. In some embodiments, an example in which the electronic device is a server is used for description. As shown in FIG. 22, the electronic device includes a memory 2102 and a processor 2104. The memory 2102 has a computer program stored therein. The processor 2104 is configured to perform the operations in any one of the foregoing method embodiments through the computer program.

In some embodiments, the foregoing electronic device may be located in at least one of a plurality of network devices in a computer network.

In some embodiments, the foregoing processor may be configured to perform the following operations through the computer program.

S1: Obtain a simulated palmprint picture, the simulated palmprint picture including a simulated palmprint curve obtained by combining curves of a target type.

S2: Input the simulated palmprint picture and a preset first noise vector into a trained target palmprint picture generator, and perform a plurality of downsampling operations and a plurality of upsampling operations on the simulated palmprint picture in sequence through the target palmprint picture generator, to generate a target palmprint picture,
each of the downsampling operations being configured for performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and
each of the upsampling operations being configured for performing upsampling processing on the inputted picture representation vector to obtain an upsampled picture representation vector, and performing noise addition processing on the upsampled picture representation vector through the first noise vector, to obtain a noise-added picture representation vector.

In some embodiments, a person of ordinary skill in the art may understand that the structure shown in FIG. 22 is merely an example. The electronic device may also be a terminal device such as a smartphone (such as an Android mobile phone or an iOS mobile phone), a tablet computer, a palm computer, a mobile Internet device (MID), or a PAD. A structure of the foregoing electronic device is not limited in FIG. 22. For example, the electronic device may further include more or fewer components (for example, a network interface) than those shown in FIG. 22, or has a configuration different from that shown in FIG. 22.

The memory 2102 may be configured to store a software program and a module, for example, program instructions/modules corresponding to the palmprint picture generation method and apparatus in various embodiments, and the processor 2104 performs various functional applications and data processing by running the software program and the module stored in the memory 2102, so as to implement the foregoing palmprint picture generation method. The memory 2102 may include a high-speed random memory, and may further include a non-volatile memory, such as one or more magnetic storage apparatuses, a flash memory, or another non-volatile solid-state memory. In some embodiments, the memory 2102 may further include memories remotely arranged relative to the processor 2104, and the remote memories may be connected to a terminal through a network. Examples of the foregoing network include, but are not limited to, the Internet, an intranet, a local area network, a mobile communication network, and a combination thereof. The memory 2102 may specifically be, but is not limited to, being configured to store information such as a sample feature of an item and a target virtual resource account. In an example, as shown in FIG. 22, the foregoing memory 2102 may include, but is not limited to, the obtaining unit 2002 and the input unit 2004 in the foregoing palmprint picture generation apparatus. In addition, the memory may further include, but is not limited to, another module unit in the foregoing palmprint picture generation apparatus. Details are not described again in this example.

In some embodiments, a transmission apparatus 2106 is configured to receive or transmit data through a network. A specific example of the foregoing network may include a wired network and a wireless network. In an example, the transmission apparatus 2106 includes a network interface controller (NIC), which may be connected to another network device and a router through a network cable to communicate with the Internet or a local area network. In an example, the transmission apparatus 2106 is a radio frequency (RF) module, which is configured to communicate with the Internet in a wireless manner.

In addition, the foregoing electronic device further includes: a display 2108, configured to display the foregoing to-be-processed order information; and a connection bus 2110, configured to connect various module components in the foregoing electronic device.

In some embodiments, the foregoing terminal device or the server may be a node in a distributed system. The distributed system may be a blockchain system. The blockchain system may be a distributed system formed through connection of a plurality of nodes in the form of network communication. A peer-to-peer (P2P) network may be formed between the nodes. Any form of computing device, such as an electronic device including a server and a terminal, may become a node in the blockchain system by joining the P2P network.

According to some embodiments, a computer program product is provided, the computer program product including a computer program/instruction, the computer program/instruction including program code for performing the method shown in the flowchart. In such an embodiment, the computer program may be downloaded and installed from a network through a communication part 2209, and/or installed from a removable medium 2211. When the computer program is executed by a central processing unit (CPU) 2201, various functions provided in the embodiments of this application are executed.

The sequence numbers of the foregoing embodiments of this application are merely for description, and do not represent the preference of the embodiments.

FIG. 23 is a structural block diagram schematically showing a computer system of an electronic device according to some embodiments.

A computer system 2200 of the electronic device shown in FIG. 23 is merely an example, and does not constitute any limitation on functions and a range of application of the embodiments.

As shown in FIG. 23, the computer system 2200 includes a CPU 2201, which may perform various suitable actions and processing based on a program stored in a read-only memory (ROM) 2202 or a program loaded from a storage part 2208 into a random access memory (RAM) 2203. The RAM 2203 further has various programs and data required for system operation stored therein. The CPU 2201, the ROM 2202, and the RAM 2203 are connected to each other through a bus 2204. An input/output interface (I/O interface) 2205 is also connected to the bus 2204.

The following components are connected to the I/O interface 2205: an input part 2206 including a keyboard, a mouse, or the like; an output part 2207 including a cathode ray tube (CRT), a liquid crystal display (LCD), a speaker, or the like; the storage part 2208 including a hard disk, or the like; and a communication part 2209 including a network interface card such as a local area network (LAN) card and a modem. The communication part 2209 performs communication through a network such as the Internet. A drive 2210 is also connected to the I/O interface 2205 as required. A removable medium 2211 such as a magnetic disk, an optical disk, a magneto-optical disk, or a semiconductor memory is installed on the drive 2210 as required, so that a computer program read from the removable medium is installed into the storage part 2208 as required.

According to some embodiments, the process described in each method flowchart may be implemented as a computer software program. For example, some embodiments include a computer program product, the computer program product including a computer program carried on a computer-readable medium, the computer program including program code for performing the methods shown in the flowcharts. In some embodiments, the computer program may be downloaded and installed from a network through a communication part 2209, and/or installed from a removable medium 2211. When the computer program is executed by the CPU 2201, various functions defined in the system are executed.

According to some embodiments, a computer-readable storage medium is provided. A processor of a computer device reads a computer instruction from the computer-readable storage medium. The processor executes the computer instruction, causing the computer device to perform the method provided in the foregoing various optional implementations.

In some embodiments, a person of ordinary skill in the art may understand that all or some operations of the various methods in the foregoing embodiments may be performed by instructing related hardware of a terminal device through a program. The program may be stored in a computer-readable storage medium. The storage medium may include: a flash drive, a ROM, a RAM, a magnetic disk, an optical disk, or the like.

When the integrated unit in the foregoing embodiment is implemented in the form of a software function unit and sold or used as an independent product, the integrated unit may be stored in the foregoing computer-readable storage medium. Based on such an understanding, the technical solutions of this application essentially, or the part contributing to the prior art, or all or a part of the technical solutions may be implemented in the form of a software product. The computer software product is stored in a storage medium, and includes several instructions for enabling one or more computer devices (which may be a personal computer, a server, a network device, or the like) to perform all or a part of the operations of the method described herein.

In some embodiments, the descriptions of the embodiments have respective emphasis. For a part not described in detail in an embodiment, reference may be made to related descriptions of other embodiments.

In some embodiments, the disclosed client may be implemented in another manner. The apparatus embodiment described above is merely an example. For example, division of the units is merely division of logical functions, and may be another division during actual implementation. For example, a plurality of units or components may be combined or may be integrated into another system, or some features may be ignored or not performed. In addition, the displayed or discussed mutual coupling or direct coupling or communication connection may be implemented through some interfaces. The indirect coupling or communication connection between the units or modules may be implemented in electrical or other forms.

The units described as separate components may or may not be physically separated, and the components displayed as units may or may not be physical units, and may be located in one place or may be distributed on a plurality of network units. Some or all of the units may be selected based on an actual need to achieve the objectives of the solutions of the embodiments.

In addition, the functional units in various embodiments may be integrated into one processing unit, or each of the units may exist alone physically, or two or more units may be integrated into one unit. The integrated unit may be implemented in a form of hardware, or may be implemented in a form of a software functional unit.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A palmprint picture generation method, performed by an electronic device, comprising:
obtaining a simulated palmprint picture comprising a simulated palmprint curve obtained by combining curves of a target type; and
inputting the simulated palmprint picture and a preset first noise vector into a target palmprint picture generator, and performing a plurality of downsampling operations and a plurality of upsampling operations on the simulated palmprint picture in sequence through the target palmprint picture generator to generate a target palmprint picture,
wherein each of the downsampling operations comprises performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and
wherein each of the upsampling operations comprises performing upsampling processing on the inputted picture representation vector to obtain an upsampled picture representation vector, and performing noise addition processing on the upsampled picture representation vector through the first noise vector, to obtain a noise-added picture representation vector.

2. The palmprint picture generation method according to claim 1, wherein the target palmprint picture generator comprises P downsampling modules and Q upsampling modules, P and Q being positive integers, and
wherein the inputting the simulated palmprint picture and the preset first noise vector into a target palmprint picture generator, and performing the plurality of downsampling operations and the plurality of upsampling operations on the simulated palmprint picture in sequence through the target palmprint picture generator comprises:
determining the initial picture representation vector based on the simulated palmprint picture;
performing the downsampling operation on the initial picture representation vector through the P downsampling modules in sequence, to obtain a P^{th} noise-added picture representation vector, each of the P downsampling modules comprising a downsampling submodule and a first conditional generation submodule;
performing the upsampling operation on the P^{th} noise-added picture representation vector through the Q upsampling modules in sequence, to obtain a Q^{th} noise-added picture representation vector, each of the Q upsampling modules comprising an upsampling submodule and a second conditional generation submodule; and
generating the target palmprint picture based on the Q^{th} noise-added picture representation vector.

3. The palmprint picture generation method according to claim 2, wherein the performing the downsampling operation on the initial picture representation vector through the P downsampling modules in sequence comprises:
obtaining an i^{th} noise-added picture representation vector through the following operations, i being a positive integer greater than or equal to 1 and less than or equal to P;
performing, through the downsampling submodule in an i^{th} downsampling module, the downsampling processing on the picture representation vector inputted into the i^{th} downsampling module, to obtain an i^{th} downsampled picture representation vector; and
performing, through the first conditional generation submodule in the i^{th} downsampling module, the noise addition processing on the i^{th} downsampled picture representation vector by using the first noise vector, to obtain an i^{th} noise-added picture representation vector.

4. The palmprint picture generation method according to claim 3, wherein the first conditional generation submodule comprises a first group of fully connected (FC) layers and a second group of FC layers, and
wherein the performing, through the first conditional generation submodule in the i^{th} downsampling module, the noise addition processing on the i^{th} downsampled picture representation vector by using the first noise vector comprises:
passing the first noise vector through the first group of FC layers to output a first control vector;
passing the first noise vector through the second group of FC layers to output a second control vector; and
performing, based on the first control vector and the second control vector, the noise addition processing on the i^{th} downsampled picture representation vector, to obtain the i^{th} noise-added picture representation vector.

5. The palmprint picture generation method according to claim 2, wherein the performing the upsampling operation on the P^{th} noise-added picture representation vector through the Q upsampling modules in sequence comprises:
obtaining a j^{th} noise-added picture representation vector through the following operations, j being a positive integer greater than or equal to 1 and less than or equal to Q;
performing, through the upsampling submodule in a j^{th} upsampling module, the upsampling processing on the picture representation vector inputted into the j^{th} upsampling module, to obtain a j^{th} upsampled picture representation vector; and
performing, through the second conditional generation submodule in the j^{th} upsampling module, the noise addition processing on the j^{th} upsampled picture representation vector by using the first noise vector, to obtain a j^{th} noise-added picture representation vector.

6. The palmprint picture generation method according to claim 5, wherein the second conditional generation submodule comprises a third group of FC layers and a fourth group of FC layers, and
wherein the performing, through the upsampling submodule in the j^{th} upsampling module, the upsampling processing on the picture representation vector inputted into the j^{th} upsampling module comprises:
passing the first noise vector through the third group of FC layers to output a third control vector;
passing the first noise vector through the fourth group of FC layers to output a fourth control vector; and
performing, based on the third control vector and the fourth control vector, the noise addition processing on the j^{th} upsampled picture representation vector, to obtain the j^{th} noise-added picture representation vector.

7. The palmprint picture generation method according to claim 2, wherein the determining the initial picture representation vector based on the simulated palmprint picture comprises:
performing first convolution processing on the simulated palmprint picture to obtain the initial picture representation vector; and
wherein the generating comprises:
performing second convolution processing on the Q^{th} noise-added picture representation vector to obtain the target palmprint picture.

8. The palmprint picture generation method according to claim 1, further comprising:
performing a plurality of rounds of training on a to-be-trained palmprint picture generator through a group of simulated palmprint sample pictures and a group of first real palmprint pictures, until a target loss value corresponding to the to-be-trained palmprint picture generator satisfies a preset convergence condition; and
determining a palmprint picture generator at the end of training as the target palmprint picture generator.

9. The palmprint picture generation method according to claim 8, wherein the performing the plurality of rounds of training on the to-be-trained palmprint picture generator through the group of simulated palmprint sample pictures and the group of first real palmprint pictures comprises:
performing a k^{th} round of training on the to-be-trained palmprint picture generator through the following operations, k being a positive integer greater than or equal to 2;
encoding the first real palmprint pictures used in the k^{th} round to obtain a picture representation vector in the k^{th} round;
inputting the picture representation vector in the k^{th} round and the first simulated palmprint sample pictures used in the k^{th} round into a palmprint picture generator obtained after a (k−1)^{th} round of training, to obtain a first palmprint picture generated in the k^{th} round;
determining a first loss value in the k^{th} round based on the first real palmprint pictures used in the k^{th} round and the first palmprint picture generated in the k^{th} round;
determining a target loss value in the k^{th} round based on the first loss value in the k^{th} round;
adjusting a parameter in the palmprint picture generator obtained after the (k−1)^{th} round of training when the target loss value in the k^{th} round does not satisfy the preset convergence condition, to obtain a palmprint picture generator obtained after the k^{th} round of training; and
ending the training when the target loss value in the k^{th} round satisfies the preset convergence condition.

10. The palmprint picture generation method according to claim 9, further comprising:
discriminating, through a trained target discriminator, the first real palmprint pictures used in the k^{th} round and the first palmprint picture generated in the k^{th} round, to obtain a first discrimination result in the k^{th} round; and
determining a second loss value in the k^{th} round based on the first discrimination result in the k^{th} round; and
wherein the determining the target loss value in the k^{th} round based on the first loss value in the k^{th} round comprises:
determining the target loss value in the k^{th} round based on the first loss value in the k^{th} round and the second loss value in the k^{th} round.

11. The palmprint picture generation method according to claim 10, further comprising:
inputting a noise vector in the k^{th} round and the first simulated palmprint sample pictures used in the k^{th} round into the palmprint picture generator obtained after the (k−1)^{th} round of training, to obtain a second palmprint picture generated in the k^{th} round; and
determining a third loss value in the k^{th} round based on the first palmprint picture generated in the k^{th} round and the second palmprint picture generated in the k^{th} round,
wherein the determining the target loss value in the k^{th} round based on the first loss value in the k^{th} round and the second loss value in the k^{th} round comprises:
determining the target loss value in the k^{th} round based on the first loss value in the k^{th} round, the second loss value in the k^{th} round, and the third loss value in the k^{th} round.

12. The palmprint picture generation method according to claim 11, further comprising:
determining a fourth loss value in the k^{th} round based on the noise vector in the k^{th} round and the picture representation vector in the k^{th} round,
wherein the determining the target loss value in the k^{th} round based on the first loss value in the k^{th} round, the second loss value in the k^{th} round, and the third loss value in the k^{th} round comprises:
determining the target loss value in the k^{th} round based on the first loss value in the k^{th} round, the second loss value in the k^{th} round, the third loss value in the k^{th} round, and the fourth loss value in the k^{th} round.

13. The palmprint picture generation method according to claim 12, further comprising:
discriminating, through the target discriminator, a second real palmprint picture used in the k^{th} round and the second palmprint picture generated in the k^{th} round, to obtain a second discrimination result in the k^{th} round; and
determining a fifth loss value in the k^{th} round based on the second discrimination result in the k^{th} round,
wherein the determining the target loss value in the k^{th} round based on the first loss value in the k^{th} round, the second loss value in the k^{th} round, the third loss value in the k^{th} round, and the fourth loss value in the k^{th} round comprises:
determining the target loss value in the k^{th} round based on the first loss value in the k^{th} round, the second loss value in the k^{th} round, the third loss value in the k^{th} round, the fourth loss value in the k^{th} round, and the fifth loss value in the k^{th} round.

14. The palmprint picture generation method according to claim 1, further comprising:
training a to-be-trained palmprint picture matching model through a set of palmprint pictures, to obtain a target palmprint picture matching model, the set of palmprint pictures comprising the target palmprint picture and another palmprint picture, the another palmprint picture being generated in the same manner as the target palmprint picture; and the target palmprint picture matching model being configured to match an inputted group of palmprint pictures, the group of palmprint pictures comprising a to-be-confirmed palmprint picture and a collected palmprint picture.

15. The palmprint picture generation method according to claim 1, further comprising:
combining Bezier curves to obtain the simulated palmprint curve, the curves of the target type comprising the Bezier curves; and
generating the simulated palmprint picture comprising the simulated palmprint curve.

16. The palmprint picture generation method according to claim 2, wherein
the downsampling submodule is configured to perform the downsampling processing on the inputted picture representation vector, to obtain the downsampled picture representation vector, and
the first conditional generation submodule being configured to perform noise addition processing on the downsampled picture representation vector through the first noise vector, to obtain the noise-added picture representation vector.

17. The palmprint picture generation method according to claim 2, wherein
the upsampling submodule is configured to perform the upsampling processing on the inputted picture representation vector to obtain an upsampled picture representation vector, and
the second conditional generation submodule being configured to perform the noise addition processing on the upsampled picture representation vector through the first noise vector, to obtain the noise-added picture representation vector.

18. The palmprint picture generation method according to claim 8, wherein
the to-be-trained palmprint picture generator performs the plurality of downsampling operations and the plurality of upsampling operations on the simulated palmprint sample pictures in sequence during the training, to generate a palmprint picture,
each of the downsampling operations during the training being configured for performing downsampling processing on the inputted picture representation vector to obtain the downsampled picture representation vector, and performing noise addition processing on the downsampled picture representation vector through an intermediate noise vector, to obtain the noise-added picture representation vector,
the picture representation vector inputted in a first downsampling operation during the training being an initial picture representation vector of the simulated palmprint sample pictures, and
the intermediate noise vector being a picture representation vector obtained by encoding each of the first real palmprint pictures, or being a preset noise vector;
each of the upsampling operations during the training being configured for performing upsampling processing on an inputted picture representation vector to obtain the upsampled picture representation vector, and performing noise addition processing on the upsampled picture representation vector through the intermediate noise vector, to obtain the noise-added picture representation vector; and
the target loss value being a loss value determined at least based on a first loss value,
the first loss value being a loss value between a generated palmprint picture and the first real palmprint picture, and
the intermediate noise vector being a picture representation vector obtained by encoding the first real palmprint picture when the first loss value is determined.

19. A palmprint picture generation apparatus, comprising:
at least one memory configured to store computer program code; and
at least one processor configured to read the program code and operate as instructed by the program code, the program code comprising:
obtaining code configured to cause at least one of the at least one processor to obtain a simulated palmprint picture, the simulated palmprint picture comprising a simulated palmprint curve obtained by combining curves of a target type; and
input code configured to cause at least one of the at least one processor to input the simulated palmprint picture and a preset first noise vector into a target palmprint picture generator, and perform a plurality of downsampling operations and a plurality of upsampling operations on the simulated palmprint picture in sequence through the target palmprint picture generator, to generate a target palmprint picture,
wherein each of the downsampling operations comprises performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and
wherein each of the upsampling operations comprises performing upsampling processing on the inputted picture representation vector to obtain an upsampled picture representation vector, and performing noise addition processing on the upsampled picture representation vector through the first noise vector, to obtain a noise-added picture representation vector.

20. A non-transitory computer-readable storage medium, storing computer code which, when executed by at least one processor, causes the at least one processor to at least:
obtain a simulated palmprint picture comprising a simulated palmprint curve obtained by combining curves of a target type; and
input the simulated palmprint picture and a preset first noise vector into a target palmprint picture generator, and perform a plurality of downsampling operations and a plurality of upsampling operations on the simulated palmprint picture in sequence through the target palmprint picture generator to generate a target palmprint picture,
wherein each of the downsampling operations comprises performing downsampling processing on an inputted picture representation vector to obtain a downsampled picture representation vector, and performing noise addition processing on the downsampled picture representation vector through the first noise vector, to obtain a noise-added picture representation vector, the inputted picture representation vector in a first downsampling operation being an initial picture representation vector of the simulated palmprint picture; and
wherein each of the upsampling operations comprises performing upsampling processing on the inputted picture representation vector to obtain an upsampled picture representation vector, and performing noise addition processing on the upsampled picture representation vector through the first noise vector, to obtain a noise-added picture representation vector.
